(19) United States
(12) Patent Application Publication
(10) Pub. No.: US 2022/0015358 A1
(43) Pub. Date: Jan. 20, 2022

(54) Encapsulated Biocides

(71) Applicant: LONZA LTD, Visp (CH)

(72) Inventors: Stefan Ellinger, Visp (CH); Brittany Caldwell, Gainesville, GA (US); Katrina Staggemeier, Alpharetta, GA (US); Shujun Wang, Alpharetta, GA (US); Simone Verdi, Raron (CH); Joachim Kerber, Thun (CH); Kevin E. Janak, Blauvelt, NY (US); Ulrich Mayerhoeffer, Visp (CH); Monika Jobmann, Buxtehude (DE); Alexandra Latnikova, Berlin (DE); Roshanak Lowe, Marietta, GA (US)

(21) Appl. No.: 17/294,128

(22) PCT Filed: Nov. 14, 2019
(86) PCT No.: PCT/EP2019/081332

§ 371 Date: May 14, 2021

Related U.S. Application Data
(60) Provisional application No. 62/768,227, filed on Nov. 16, 2018.

(30) Foreign Application Priority Data
Nov. 16, 2018 (EP) 18206778.5
Jun. 13, 2019 (EP) 19180117.4
Jun. 18, 2019 (EP) 19180948.2

(51) Int. Cl. A01N 25/28; A01N 47/30; C09D 5/14

(52) U.S. Cl. CPC A01N 25/28; C09D 5/14; A01N 47/30

(57) ABSTRACT

The invention discloses a method for protecting coating compositions selected from the group consisting of architectural (interior and exterior) and marine paints and coatings, sealants (for example PU, Epoxy, Silicone), fishnet coatings, construction paints and coatings, oil and gas coatings, wood composite coatings and wood composites plastics, flooring paints and coatings, and combinations thereof; against microorganisms by the use of microencapsulated biocides, wherein the encapsulation is realized with a polyurea polymer.

The invention discloses a method for protecting coating compositions selected from the group consisting of architectural (interior and exterior) and marine paints and coatings, sealants (for example PU, Epoxy, Silicone), fishnet coatings, construction paints and coatings, oil and gas coatings, wood composite coatings and wood composites plastics, flooring paints and coatings, and combinations thereof; against microorganisms by the use of microencapsulated biocides, wherein the encapsulation is realized with a polyurea polymer.

### BACKGROUND OF THE INVENTION

Diuron, that is 3-(3,4-dichlorophenyl)-1,1-dimethylurea, is known for its algaetoxic effect and is used as an algicide in coating compositions such as paints, especially in water based coating compositions, such as water based paints, in order to prevent algae infestation on external walls. Coating compositions are exposed to the weather and the algicide can be washed out of the coating compositions, this phenomenon is called “leaching”. Thereby the algaetoxic effect is not stable over time but is reduced prematurely, furthermore the algaecide is released uncontrolled to the environment.

US 2016/0088837 A1 discloses diuron encapsulated by a melamine-formaldehyde polymer. For the preparation of the encapsulation, formaldehyde is typically used in molar excess.

EP 0 679 333 A2 discloses in examples 1 and 2 encapsulation of DCOIT with polyurethane in the presence of phthalates. Phthalates are used for dissolving the DCOIT, thereby DCOIT is present in dissolved form and not in solid form. The interfacial polymerization is done in an oil in water emulsion (O/W). Thereby the small emulsion droplets of the organic phase will be encapsulated by the polyurethane, these droplets comprise the DCOIT, the phthalate and xylene. At the end of the procedure the solid particles, that is the microcapsules, are isolated by vacuum filtration and subsequent air drying. Xylene has a boiling point of ca. 140° C., phthalate has a boiling point of ca. 385° C., thereby xylene may be removed partially during this air drying, whereas the phthalate will not be removed. This results in microcapsules having a content of phthalate.

Phthalates are used as plasticizers and legal provisions and growing environmental awareness and perceptions, increasingly force producers to use avoid the use of phthalates.

JP 2002 053412 A discloses in examples 2 and 3 encapsulation of OIT with polyurethane or polyurea from an emulsion. OIT is liquid at ambient temperature. Therefore OIT is present during the polymerization in liquid or dissolved form, dissolved in the isocyanate, but not in solid form. The polymerization is done without a solvent which necessitates mandatorily that a liquid biocide is used, and not a solid biocide, because a solid biocide would not disperse satisfactorily in an organic phase, which consists essentially of the isocyanate and comprises no solvent, and it would not be possible with a solid biocide, but without a solvent, to create an O/W (oil in water) emulsion in the required quality to provide for a desired fine and homogeneous particle size distribution of any microcapsules.

WO 2017/095335 A 1 discloses in example 4 encapsulation of DCOIT with polyurethane in the presence of linseed oil from an emulsion, that means that the DCOIT is present in liquid or rather in dissolved form, but not in solid form; it is dissolved in eth mixture of diisocyanate and linseed oil. The linseed oil is used dissolving the DCOIT. The interfacial polymerization is done in an oil in water emulsion (O/W). Thereby the small emulsion droplets of the organic phase will be encapsulated by the polyurethane, these droplets comprise the DCOIT and the linseed oil. This results in microcapsules having a content of linseed oil. At the end of the procedure a dispersion of such microcapsules is obtained.

The use of linseed oil is avoided in high performance coatings due to is propensity of yellowing, of developing a rancid smell and of not providing for high hardness properties of cured coatings.

In addition these dispersions can be used only in water based binders and are therefore not as versatile usable.

Therefore, there was a need for coating compositions, such as paints, which show reduced leaching behavior of biocides such as algaecides, thereby preserving the algaetoxic effect over a longer time, and which do not use formaldehyde for their preparation. Lower leaching behavior allows to use smaller quantitative amounts of biocide for the protection of coating compositions, and to achieve longer action times. The method should not required the use of linseed oil or phthalates. It would be beneficial if the microcapsules do not contain significant amounts of any solvent, linseed oil or phthalates.

Surprisingly, the method of instant invention meets the described needs, in particular no significant amounts of any solvent, linseed oil or phthalates are present in the microcapsules.

Furthermore the method of instant invention allows the use of biocides in solid form during polymerization. In the method of instant invention it is not required to use, in addition to the chosen solvent, which is removed at the end of the procedure from the microcapsule, any further substances for solubilizing the biocide in the organic phase during polymerization.

Comparative example 2 shows that the invention has reduced leaching rates compared to US 2016/0088837 A1.

The following abbreviations are used, if not otherwise stated:
DABCO CAS 280-57-9, 1,4-Diazabicyclo[2.2.2]octane
DMCHA dimethylcyclohexylamine
DMEA dimethylethanolamine
Gum Arabic a natural gum consisting of the hardened sap of various species of the acacia tree
HDMI hydrogenated methylendi(phenylisocyanate)
MDI Methylendi(phenylisocyanate)
MTBE methyl tert-butyl ether
MW molecular weight [g/mol]
O/W emulsion oil-in-water emulsion
PEG Poly (ethylene glycol)
PEG-PPG-PEG poly (ethylene glycol)-block-poly (propylene glycol)-block-poly (ethylene glycol)
PMDI Polymeric methylendi(phenylisocyanate)
PPG poly (propylene glycol)
PVA Polyvinylalcohol
PVFD Polyvinylidene fluoride
W/O/W emulsion water-in-oil-in-water emulsion
wt % weight percent

### SUMMARY OF THE INVENTION

Subject of the invention is a method METHENCAPS for preparation of microcapsules MICROCAPS;
with MICROCAPS comprising a biocide BIOC and a microencapsulation material MICROENCAPSMAT;
   BIOC is a biocide that is active against microorganisms;
   MICROENCAPSMAT comprises a polyurea polymer POLYUREAPOLYM;
METHENCAPS comprises a polymerization POLYM of a polyisocyanate ISOCYAN in the presence of water, or of ISOCYAN with a polyamine, or by a combination of both;
POLYM provides POLYUREAPOLYM;
BIOC is present during POLYM and is microencapsulated by MICROENCAPSMAT during POLYM;
wherein
BIOC is present in POLYM in solid form.

### DETAILED DESCRIPTION OF THE INVENTION

Preferably, BIOC is selected from the group consisting of biocides of the urea type, such as
compound of formula I

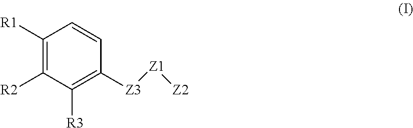

chlorbromuron with CAS No. 13360-45-7, chlortoluron with CAS No. 15545-48-9, Diuron with CAS No. 330-54-1, Difenoxuron with CAS No. 14214-32-5, Fluometuron with CAS No. 2164-17-2, Isoproturon with CAS No. 34123-59-6, Neburon with CAS No. 555-37-3, Metoxuron with CAS No. 19937-59-8, Monuron with CAS No. 150-68-5, Monolinuron with CAS No. 1746-81-2, Metobromuron with CAS No. 3060-89-7, Linuron with CAS No. 330-55-2, Ethidimoron with CAS No. 30043-49-3, Fenuron with CAS No. 101-42-8, Isouron with CAS No. 55861-78-4, Methabenzthiazuron with CAS No. 18691-97-9, Metobromuron with CAS No. 3060-89-7, Monolinuron with CAS No. 1746-81-2, Siduron with CAS No. 1982-49-6, Tebuthiuron with CAS No. 34014-18-1, and Chloroxuron with CAS No. 1982-47-4,
biocides of the triazine type, such as Simazine with CAS No. 122-34-9, Propazin with CAS No. 139-40-2, Terbutryn with CAS No. 886-50-0, Cybutryn with CAS No. 28159-98-0, Desmetryne with CAS No. 1014-69-3, Terbuthylazine with CAS No. 5915-41-3, Simetryne with CAS No. 1014-70-6, Dimethametryn with CAS No. 22936-75-0, Atrazine with CAS No. 1912-24-9, Cyanazine with CAS No. 21725-46-2, Prometryne with CAS No. 7287-19-6, and Trietazine with CAS No. 1912-26-1,
biocides of the triazolinone type, such as Amicarbazone with CAS No. 129909-90-6,
biocides of the triazinone type, such as Hexazinone with CAS No. 51235-04-2, Metamitron with CAS No. 41394-05-2, and Metribuzin with CAS No. 21087-64-9,
biocides of the pyridazinone type, such as Chloridazon with CAS No. 1698-60-8,
biocides of the uracil type, such as Bromacil with CAS No. 314-40-9, Lenacil with CAS No. 2164-08-1, and Terbacil with CAS No. 5902-51-2,
biocides of the phenylcarbamate type, such as Desmedipham with CAS No. 13684-56-5, and Phenmedipham with CAS No. 13684-63-4,
biocides of the amide type, such as Pentanochlor with CAS No. 2307-68-8, and Propanil with CAS No. 709-98-8,
biocides of the nitrile type, such as Bromofenoxim with CAS No. 13181-17-4, Ioxynil with CAS No. 1689-83-4, and Bromoxynil with CAS No. 1689-84-5,
biocides of the phenyl-pyridazine type, such as Pyridafol with CAS No. 40020-01-7, and Pyridate with CAS No. 55512-33-9,
biocides of the isothiazolinon type, such as BIT, also called Proxan, with CAS No. 2634-33-5, OIT, also called Octhilinon, with CAS No. 26530-20-1, MIT with CAS No. 2682-20-4, CMIT with CAS No. 26172-55-4, DCOIT with CAS No. 64359-81-5, and BBIT, also called Butylbenzisothiazolinon, with CAS No. 4299-07-4,
biocides of the iodopropargyl type, such as IPBC, also called Iodocarb, with CAS No. 55406-53-6, 3-iodo-2-propynyl propylcarbamate, 3-iodo-2-propynyl m-chlorophenylcarbamate, 3-iodo-2-propynyl phenylcarbamate, 3-iodo-2-propynyl 2,4,5-trichlorophenyl ether, 3-iodo-2-propynyl 4-chlorophenyl formal, also called IPCF, di-(3-iodo-2-propynyl) hexyl dicarbamate, 3-iodo-2-propynyl oxyethanol ethylcarbamate, 3-iodo-2-propynyl oxyethanol phenylcarbamate, 3-iodo-2-propynyl thioxothioethylcarbamate, 3-iodo-2-propynyl carbamic acid ester, also called IPC, N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorophenyl 3-iodopropargyl formal, 3-bromo-2,3-diiodo-2-propenylethyl carbamate, 3-iodo-2-propynyl-n-hexyl carbamate, 3-iodo-2-propynyl cyclohexyl carbamate,
biocides of the quaternary amine type, such as compound of formula (XV),

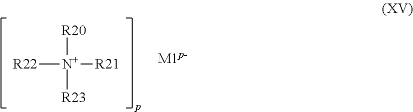

and other biocides such as Tebuconazole with CAS No. 107534-96-3, fuberidazol with CAS No. 3878-19-1, triflumizole with CAS No. 68694-11-1, Farnesol with CAS No. 4602-84-0, etridiazole with CAS No. 2593-15-9, cyprodinil with CAS No. 121552-61-2, Cyazofamid with CAS No. 120116-88-3, Fluorimide with CAS No. 41205-21-4, Penflufen with CAS No. 494793-67-8, Propiconazole with CAS No. 60207-90-1, fenbuconazole with CAS No. 114369-43-6, zoxamide with CAS No. 156052-68-5, Quinoxyfen with CAS No. 124495-18-7, proquinazid with CAS No. 189278-12-4, triticonazole with CAS No. 131983-72-7, fluopicolide with CAS No. 239110-15-7, Oryzalin with CAS No. 19044-88-3, Dichlofluanid with CAS No. 1085-98-9, Dithiopyr with CAS No. 97886-45-8, Ethalfluralin with CAS No. 55283-68-6, Ethofumesate with CAS No. 26225-79-6, Ethoxyquin with CAS No. 91-53-2, Ethyl 1-naphthaleneacetate with CAS No. 2122-70-5, Etoxazole with CAS No. 153233-91-1, Etridiazole with CAS No. 2593-15-9, Famoxadone with CAS No. 131807-57-3, Fenamidone with CAS No. 161326-34-7, Fenbuconazole with CAS No. 114369-43-6, Fenhexamid with CAS No. 126833-17-8, Fenoxanil with CAS No. 115852-48-7, Fenoxaprop-p-ethyl with CAS No. 71283-80-2, Fenpropimorph with CAS No. 67564-91-4, Fenpyrazamine with CAS No. 473798-59-3, Fluazifop-P-butyl with CAS No. 79241-46-6, Fluazinam with CAS No. 79622-59-6, Fludioxonil with CAS No. 131341-86-1, Flufenacet with CAS No. 142459-58-3, Flufenpyr-ethyl with CAS No. 188489-07-8, Flumetsulam with CAS No. 98967-40-9, Flumiclorac with CAS No. 87546-18-7, Flumioxazin with CAS No. 103361-09-7, Fluometuron with CAS No. 2164-17-2, Fluopicolide with CAS No. 239110-15-7, Fluopyram with CAS No. 658066-35-4, Fluorimide with CAS No. 161288-34-2, Fluoxastrobin with CAS No. 361377-29-9, Fluridone with CAS No. 59756-60-4, Fluroxypyr 1-methylheptyl ester with CAS No. 81406-37-3, Fluthiacet-methyl with CAS No. 117337-19-6, Flutianil with CAS No. 958647-10-4, Flutolanil with CAS No. 66332-96-5, Fluxapyroxad with CAS No. 907204-31-3, Foramsulfuron with CAS No. 173159-57-4, Fuberidazole with CAS No. 3878-19-1, gamma-Cyhalothrin with CAS No. 76703-62-3, Halosulfuron-methyl with CAS No. 100784-20-1, Hexythiazox with CAS No. 78587-05-0, Imazalil sulphate with CAS No. 58594-72-2, Imazaquin with CAS No. 81335-37-7, Ipconazole with CAS No. 125225-28-7, Iprodione with CAS No. 36734-19-7, Iprovalicarb with CAS No. 140923-17-7, Isofetamid with CAS No. 875915-78-9, Isopyrazam with CAS No. 881685-58-1, Isoxaben with CAS No. 82558-50-7, Isoxaflutole with CAS No. 141112-29-0, Kresoxim-methyl with CAS No. 143390-89-0, Lactofen with CAS No. 77501-63-4, Linuron with CAS No. 330-55-2, Mancozeb with CAS No. 8018-01-7, Mandestrobin with CAS No. 173662-97-0, Mandipropamid with CAS No. 374726-62-2, MCPB (and salts) with CAS No. 94-81-5, Mecoprop-P with CAS No. 16484-77-8, Mepanipyrim with CAS No. 110235-47-7, meptyldinocap with CAS No. 131-72-6, Methylene bis(thiocyanate) with CAS No. 6317-18-6, Metiram with CAS No. 9006-42-2, Metolachlor with CAS No. 51218-45-2, Metrafenone with CAS No. 220899-03-6, Myclobutanil with CAS No. 88671-89-0, Napropamide with CAS No. 15299-99-7, Neodecanamide, N-methyl- with CAS No. 105726-67-8, Niclosamide with CAS No. 1420-04-8, Norflurazon with CAS No. 27314-13-2, Noviflumuron with CAS No. 121451-02-3, Oxadiazon with CAS No. 19666-30-9, Oxyfluorfen with CAS No. 42874-03-3, Paclobutrazol with CAS No. 76738-62-0, Penconazole with CAS No. 66246-88-6, Pendimethalin with CAS No. 40487-42-1, Penoxsulam with CAS No. 219714-96-2, Pentachloronitrobenzene with CAS No. 82-68-8, Penthiopyrad with CAS No. 183675-82-3, Phenmedipham with CAS No. 13684-63-4, Picloram with CAS No. 1918-02-1, Picoxystrobin with CAS No. 117428-22-5, Piperalin with CAS No. 3478-94-2, Pirimiphos-methyl with CAS No. 29232-93-7, Prallethrin with CAS No. 23031-36-9, Prodiamine with CAS No. 29091-21-2, Profenofos with CAS No. 41198-08-7, Prometryn with CAS No. 7287-19-6, Propanil with CAS No. 709-98-8, Propargite with CAS No. 2312-35-8, Propazine with CAS No. 139-40-2, Propyzamide with CAS No. 23950-58-5, Proquinazid with CAS No. 189278-12-4, Prosulfuron with CAS No. 94125-34-5, Pyraclostrobin with CAS No. 175013-18-0, Pyraflufen-ethyl with CAS No. 129630-19-9, Pyribencarb with CAS No. 799247-52-2, Pyrimethanil with CAS No. 53112-28-0, Pyriofenone with CAS No. 688046-61-9, Quinclorac with CAS No. 84087-01-4, Quinoxyfen with CAS No. 124495-18-7, Quinoxyfen with CAS No. 878790-59-1, Quizalofop with CAS No. 76578-14-8, Quizalofop-p-ethyl with CAS No. 100646-51-3, Rotenone with CAS No. 83-79-4, Sedaxane with CAS No. 874967-67-6, Siduron with CAS No. 1982-49-6, Silthiofam with CAS No. 175217-20-6, Simazine with CAS No. 122-34-9, S-Metolachlor with CAS No. 87392-12-9, Sodium salt of fomesafen with CAS No. 108731-70-0, Sulfometuron with CAS No. 74222-97-2, Temephos with CAS No. 3383-96-8, Terbuthylazine with CAS No. 5915-41-3, Tetraconazole with CAS No. 112281-77-3, Thiabendazole with CAS No. 148-79-8, Thiabendazole hypophosphite with CAS No. 28558-32-9, Thidiazuron with CAS No. 51707-55-2, Thiobencarb with CAS No. 28249-77-6, Thiophanate-methyl with CAS No. 23564-05-8, Thiram with CAS No. 137-26-8, Tolclofos-methyl with CAS No. 57018-04-9, Triadimefon with CAS No. 43121-43-3, Triadimenol with CAS No. 55219-65-3, Triallate with CAS No. 2303-17-5, Triasulfuron with CAS No. 82097-50-5, Triazoxide with CAS No. 72459-58-6, Tribenuron-methyl with CAS No. 101200-48-0, Triclopyr butoxyethyl ester with CAS No. 64700-56-7, Triclopyricarb with CAS No. 55335-06-3, Trifloxystrobin with CAS No. 141517-21-7, Triflumizole with CAS No. 68694-11-1, Trifluralin with CAS No. 1582-09-8, Triflusulfuron-methyl with CAS No. 126535-15-7, Triforine with CAS No. 26644-46-2, Triticonazole with CAS No. 131983-72-7, Valifenalate with CAS No. 283159-90-0, Warfarin with CAS No. 81-81-2, Ziram with CAS No. 137-30-4, Zoxamide with CAS No. 156052-68-5, Zinc pyrithione with CAS No. 13463-41-7, and copper pyrithione for example with CAS No. 14915-37-8;
   where
R1 and R2 are identical or different and are independently from each other selected from the group consisting of H, Cl, Br, F, C₁₋₈ alkyl, C₁₋₈ alkoxy, CF₃, phenoxy or phenoxy substituted with 1 or 2 identical or different substitutents independently from each other selected from the group consisting of C₁₋₈ alkyl and C₁₋₈ alkoxy;
R3 is H, Cl, Br, F or C₁₋₈ alkyl;
R4 and R5 are identical or different and are independently from each other selected from the group consisting of H, C₁₋₈ alkyl and C₁₋₈ alkoxy;
Z1 is CH₂, CO or S(O)₂;
Z2 is N(R4)R5, O—R7 or S—R7;
Z3 is N—R6, O or S;
R6 is H, C₁₋₈ alkyl, phenyl or S—C(Cl)₂F;
R7 is H, C₁₋₈ alkyl or phenyl;
R20, R21, R22 and R23 are identical or different and are independently from each other selected from the group consisting of C₁₋₂₀ alkyl, benzyl and phenyl;
p is 1 or 2;
M1^{p-} is Cl⁻, HCO₃⁻ or CO₃²⁻.
C₁₋₈ alkyl is for example methyl, ethyl, n-propyl, isopropyl, n-butyl, isobutyl, sec-butyl, tert-butyl, n-pentyl, iso-pentyl, n-hexyl, n-heptyl or n-octyl.
C₁₋₈ alkoxy is for example, methoxy, ethoxy, n-propoxy, isopropoxy, n-butoxy, isobutoxy, sec-butoxy or tert-butoxy, O-n-pentyl, 0-iso-pentyl, O-n-hexyl, O-n-heptyl or O-n-octyl.
Preferably, R1 and R2 are identical or different and are independently from each other selected from the group consisting of H, Cl, Br, F methyl, isopropyl, methoxy, CF₃, phenoxy or para-methoxyphenoxy.
Preferably, R3 is hydrogen, Cl, Br or F.
Preferably, R4 and R5 are identical or different and are independently from each other selected from the group consisting of H, methyl, butyl and methoxy.
Preferably, Z1 is CO or S(O)₂.
Preferably, Z2 is N(R4)R5.
Preferably, Z3 is N—R6.
Preferably, R6 is H, C₁₋₄ alkyl or S—C(Cl)₂F;
more preferably, R6 is H or S—C(Cl)₂F.
Preferably, R20, R21, R22 and R23 are identical or different and are independently from each other selected from the group consisting of C₁₋₁₈ alkyl, benzyl and phenyl.
More preferably, BIOC is selected from the group consisting of
biocides of the urea type, such as
   compound of formula (I),

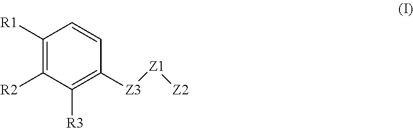

chlortoluron with CAS No. 15545-48-9, Diuron with CAS No. 330-54-1, Fluometuron with CAS No. 2164-17-2, Isoproturon with CAS No. 34123-59-6, Neburon with CAS No. 555-37-3, Monuron with CAS No. 150-68-5, Fenuron with CAS No. 101-42-8, Isouron with CAS No. 55861-78-4, Siduron with CAS No. 1982-49-6, and Tebuthiuron with CAS No. 34014-18-1,
biocides of the triazine type, such as Simazine with CAS No. 122-34-9, Propazin with CAS No. 139-40-2, Terbutryn with CAS No. 886-50-0, Cybutryn with CAS No. 28159-98-0, Simetryne with CAS No. 1014-70-6, Prometryne with CAS No. 7287-19-6, and Trietazine with CAS No. 1912-26-1,
biocides of the triazinone type, such as Hexazinone with CAS No. 51235-04-2, and Metribuzin with CAS No. 21087-64-9,
biocides of the uracil type, such as Bromacil with CAS No. 314-40-9, and Terbacil with CAS No. 5902-51-2,
biocides of the phenylcarbamate type, such as Desmedipham with CAS No. 13684-56-5, and Phenmedipham with CAS No. 13684-63-4,
biocides of the amide type, such as Pentanochlor with CAS No. 2307-68-8, and Propanil with CAS No. 709-98-8,
biocides of the nitrile type, such as Ioxynil with CAS No. 1689-83-4, and Bromoxynil with CAS No. 1689-84-5,
biocides of the phenyl-pyridazine type, such as Pyridafol with CAS No. 40020-01-7,
biocides of the isothiazolinon type, such as BIT, also called Proxan, with CAS No. 2634-33-5, OIT, also called Octhilinon, with CAS No. 26530-20-1, DCOIT with CAS No. 64359-81-5, and BBIT, also called Butylbenzisothiazolinon, with CAS No. 4299-07-4,
biocides of the iodopropargyl type, such as IPBC, also called Iodocarb, with CAS No. 55406-53-6,
biocides of the quaternary amine type, such as compound of formula (XV),
and other biocides such as Tebuconazole with CAS No. 107534-96-3, fuberidazol with CAS No. 3878-19-1, cyprodinil with CAS No. 121552-61-2, Cyazofamid with CAS No. 120116-88-3, Fluorimide with CAS No. 41205-21-4, Penflufen with CAS No. 494793-67-8, Propiconazole with CAS No. 60207-90-1, fenbuconazole with CAS No. 114369-43-6, zoxamide with CAS No. 156052-68-5, Quinoxyfen with CAS No. 124495-18-7, proquinazid with CAS No. 189278-12-4, triticonazole with CAS No. 131983-72-7, fluopicolide with CAS No. 239110-15-7, Oryzalin with CAS No. 19044-88-3, Dichlofluanid with CAS No. 1085-98-9, Etoxazole with CAS No. 153233-91-1, Etridiazole with CAS No. 2593-15-9, Fenbuconazole with CAS No. 114369-43-6, Fenhexamid with CAS No. 126833-17-8, Fenoxanil with CAS No. 115852-48-7, Fludioxonil with CAS No. 131341-86-1, Flufenacet with CAS No. 142459-58-3, Fluometuron with CAS No. 2164-17-2, Fluorimide with CAS No. 161288-34-2, Fluridone with CAS No. 59756-60-4, Fluxapyroxad with CAS No. 907204-31-3, Foramsulfuron with CAS No. 173159-57-4, Fuberidazole with CAS No. 3878-19-1, Halosulfuron-methyl with CAS No. 100784-20-1, Imazaquin with CAS No. 81335-37-7, Ipconazole with CAS No. 125225-28-7, Iprodione with CAS No. 36734-19-7, Isofetamid with CAS No. 875915-78-9, Isopyrazam with CAS No. 881685-58-1, Lactofen with CAS No. 77501-63-4, Linuron with CAS No. 330-55-2, Mecoprop-P with CAS No. 16484-77-8, Mepanipyrim with CAS No. 110235-47-7, Metolachlor with CAS No. 51218-45-2, Metrafenone with CAS No. 220899-03-6, Myclobutanil with CAS No. 88671-89-0, Norflurazon with CAS No. 27314-13-2, Noviflumuron with CAS No. 121451-02-3, Oxadiazon with CAS No. 19666-30-9, Oxyfluorfen with CAS No. 42874-03-3, Paclobutrazol with CAS No. 76738-62-0, Penconazole with CAS No. 66246-88-6, Pendimethalin with CAS No. 40487-42-1, Pentachloronitrobenzene with CAS No. 82-68-8, Penthiopyrad with CAS No. 183675-82-3, Piperalin with CAS No. 3478-94-2, Prometryn with CAS No. 7287-19-6, Propanil with CAS No. 709-98-8, Prosulfuron with CAS No. 94125-34-5, Quinoxyfen with CAS No. 124495-18-7, Quinoxyfen with CAS No. 878790-59-1, Siduron with CAS No. 1982-49-6, Sulfometuron with CAS No. 74222-97-2, Temephos with CAS No. 3383-96-8, Tetraconazole with CAS No. 112281-77-3, Thiabendazole with CAS No. 148-79-8, Thiram with CAS No. 137-26-8, Triasulfuron with CAS No. 82097-50-5, Triazoxide with CAS No. 72459-58-6, Tribenuron-methyl with CAS No. 101200-48-0, Trifluralin with CAS No. 1582-09-8, Triflusulfuron-methyl with CAS No. 126535-15-7, Triticonazole with CAS No. 131983-72-7, Ziram with CAS No. 137-30-4, Zoxamide with CAS No. 156052-68-5, Zinc pyrithione with CAS No. 13463-41-7, and copper pyrithione for example with CAS No. 14915-37-8;
with compound of formula (XV), R1, R2, R3, Z1, Z2 and Z3 as defined herein, also with all their embodiments.
Particularly preferred BIOC is selected from the group consisting of compound of formula (XV), BBIT, also called Butylbenzisothiazolinon, with CAS No. 4299-07-4, Terbutryn with CAS No. 886-50-0, Cybutryn with CAS No. 28159-98-0, Desmetryne with CAS No. 1014-69-3, Tebuconazole with CAS No. 107534-96-3, Penflufen with CAS No. 494793-67-8, fenbuconazole with CAS No. 114369-43-6, IPBC, also called Iodocarb, with CAS No. 55406-53-6, Oryzalin with CAS No. 19044-88-3, Dichlofluanid with CAS No. 1085-98-9, 3-(4-bromo-3-chlorophenyl)-1-methoxy-1-methylurea (chlorbromuron), 3-(3-chloro-4-methylphenyl)-1,1-dimethylurea (chlortoluron), 3-(3,4-dichlorophenyl)-1,1-dimethylurea (diuron), 3-(4-(4-methoxyphenoxy)phenyl)-1,1-dimethylurea (difenoxuron), 1,1-dimethyl-3-[3-(trifluoromethyl)phenyl]urea (fluometuron), 3-(4-isopropylphenyl)-1,1-dimethylurea (isoprofuron) 1-butyl-3(3,4-dichlorophenyl)-1-methylurea (neburon), Zinc pyrithione with CAS No. 13463-41-7, and copper pyrithione for example with CAS No. 14915-37-8;
more in particular preferred BIOC is selected from the group consisting of compound of formula (XV), BBIT, also called Butylbenzisothiazolinon, with CAS No. 4299-07-4, Terbutryn with CAS No. 886-50-0, Cybutryn with CAS No. 28159-98-0, Desmetryne with CAS No. 1014-69-3, Tebuconazole with CAS No. 107534-96-3, Penflufen with CAS No. 494793-67-8, fenbuconazole with CAS No. 114369-43-6, IPBC, also called Iodocarb, with CAS No. 55406-53-6, Oryzalin with CAS No. 19044-88-3, Dichlofluanid with CAS No. 1085-98-9, 3-(3,4-dichlorophenyl)-1,1-dimethylurea (diuron), 1,1-dimethyl-3-[3-(trifluoromethyl)phenyl]urea (fluometuron), and 3-(4-isopropylphenyl)-1,1-dimethylurea (isoprofuron), Zinc pyrithione with CAS No. 13463-41-7, and copper pyrithione for example with CAS No. 14915-37-8;
even more in particular preferred BIOC is selected from the group consisting of compound of formula (XV), BBIT, also called Butylbenzisothiazolinon, with CAS No. 4299-07-4, Terbutryn with CAS No. 886-50-0, Cybutryn with CAS No. 28159-98-0, Tebuconazole with CAS No. 107534-96-3, Penflufen with CAS No. 494793-67-8, IPBC, also called Iodocarb, with CAS No. 55406-53-6, Oryzalin with CAS No. 19044-88-3, Dichlofluanid with CAS No. 1085-98-9, and 3-(3,4-dichlorophenyl)-1,1-dimethylurea (diuron), Zinc pyrithione with CAS No. 13463-41-7, and copper pyrithione for example with CAS No. 14915-37-8;
very in particular preferred BIOC is selected from the group consisting of compound of formula (XV), BBIT, also called Butylbenzisothiazolinon, with CAS No. 4299-07-4, IPBC, also called Iodocarb, with CAS No. 55406-53-6, Oryzalin with CAS No. 19044-88-3, Dichlofluanid with CAS No. 1085-98-9, and 3-(3,4-dichlorophenyl)-1,1-dimethylurea (diuron), Zinc pyrithione with CAS No. 13463-41-7, and copper pyrithione for example with CAS No. 14915-37-8;
very, very in particular, BIOC is diuron;
with compound of formula (XV) as defined herein, also with all its embodiments.
The compounds of formula (I) are known compounds and can be produced by methods known in the literature or can be purchased.
The microencapsulation of BIOC is realized by means of MICROENCAPSMAT. Microencapsulation, in the context of the invention, means at least partially, preferably completely, enveloping of BIOC with MICROENCAPSMAT.
MICROENCAPSMAT forms the shell or wall of the MICROCAPS, at least partially, preferably completely; MICROENCAPSMAT is essentially POLYUREAPOLYM comprised in MICROENCAPSMAT that performs this function.
A microencapsulated BIOC, in the context of the invention, means a BIOC that is at least partial, preferably complete, enveloped with MICROENCAPSMAT.
A microcapsule MICROCAPS in the context of the invention comprises the BIOC and the microencapsulation material MICROENCAPSMAT.

MICROCAPS have preferably a volume averaged particle size of 0.3 to 100 micrometer; more preferably of 5 to 40 micrometer.
Preferably, MICROCAPS have a D10 value of from 0.2 to 10 micrometer, more preferably of from 0.2 to 5 micrometer.
Preferably, MICROCAPS have a D50 value of from 2 to 20 micrometer, more preferably of from 2 to 16 micrometer.
Preferably, MICROCAPS have a D90 value of from 5 to 40 micrometer, more preferably of from 6 to 35 micrometer, even more preferably of from 7 to 30 micrometer.

The volume averaged particle size and the D10, D50 and D90 values herein are determined according to the method description for determination of the particle size distribution as given in the example section.
Preferably, POLYUREAPOLYM is made by polymerization of an polyisocyanate ISOCYAN in the presence of water.
This type of polymerization to provide a polyurea from an polyisocyanate such as ISOCYAN in the presence of water is known: water reacts with an isocyanate residue, the reactions converts the isocyanate residue to an amine residue by release of CO₂, the formed amine residue can react with another isocyanate residue to form a urea bond, and when more than one isocyanate residue is present in ISOCYAN, then polymerization occurs.
A polyisocyanate in the sense of the invention contains two or more isocyanate residues per molecule.
Preferably, ISOCYAN is a compound of formula (XX) or a prepolymer PREPOLYM;

R30 [symbol] N═C═O]ₙ₄ (XX)

wherein
n4 is an integer that is equal or greater than 2, preferably from 2 to 502, more preferably from 2 to 202, even more preferably from 2 to 102, especially from 2 to 52, more especially from 2 to 27, even more especially from 2 to 22, in particular from 2 to 17, more in particular from 2 to 12;
R30 is a group linking the 2 or more isocyanate residues together, including any aromatic, aliphatic, or cycloaliphatic groups, or combinations of any of aromatic, aliphatic, or cycloaliphatic groups, which are capable of linking the isocyanate groups together;
PREPOLYM is an isocyanate which is prepared by a reaction between compound of formula (XX) with a compound COMPOHNH, COMPOHNH is selected from the group consisting of polyalcohol, water, polyamine, and mixtures thereof;
wherein in said reaction COMPOHNH is present in substoichiometric amounts with regard to ISOCYAN.
A wide variety of aliphatic diisocyanates, cycloaliphatic diisocyanates, and aromatic diisocyanates, wherein n4 is 2 in formula (XX), may be employed, for example, diisocyanates containing an aliphatic segment and/or containing a cycloaliphatic ring segment or an aromatic ring segment may be employed in the present invention as well.
General aliphatic diisocyanates include compound of formula (XXI);

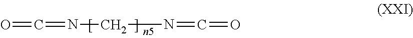

wherein
n5 is an integer having a mean value of from about 2 to about 18, preferably from about 3 to about 17, more preferably from about 4 to about 15, even more preferably from about 4 to 13;
mean value means that compound of formula (XXI) is a mixture of respective compounds and n5 is represented as a mean (or average) value;
preferably, n5 is an integer from 2 to 18, more preferably from 4 to 16, even more preferably from 6 to 14, especially from 6 to 10, more especially n5 is 6 or 9.
Preferably, n5 is 6, i.e. 1,6-hexamethylene diisocyanate. The molecular weight of 1,6-hexamethylene diisocyanate is about 168.2 g/mol. Since 1,6-hexamethylene diisocyanate comprises 2 isocyanate residues per molecule, its equivalent weight is about 84.1 g/mol. The equivalent weight of a polyisocyanate is generally defined as the molecular weight divided by the number of isocyanate residues per molecule. As noted above, in some polyisocyanates, the actual equivalent weight may differ from the theoretical equivalent weight, some of which are identified herein.
In certain embodiments, the aliphatic diisocyanates include dimers of diisocyanates, for example, a compound of formula (XXII);

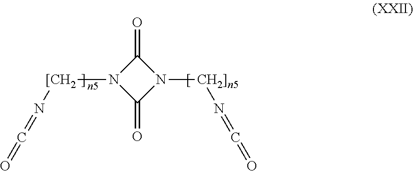

with n5 as defined above, also with all its embodiments.
Preferably, n5 in formula (XXII) is 6, i.e. compound of formula (XXII) is a dimer of 1,6-hexamethylene diisocyanate (molecular weight of about 339.39 g/mol; equivalent weight of about 183 g/mol).
A wide variety of cycloaliphatic and aromatic diisocyanates may be used as well. In general, aromatic diisocyanates include those diisocyanates wherein the R30 linking group contains an aromatic ring, and cycloaliphatic diisocyanates include those diisocyanates wherein the R linking group contains a cycloaliphatic ring. Typically, the structure of the R30 linking group in both aromatic and cycloaliphatic diisocyanates contains more moieties than just an aromatic or cycloaliphatic ring. The nomenclature herein is used to classify diisocyanates.
Certain commercially available aromatic diisocyanates comprise two benzene rings, which may be directly bonded to each other or may be connected through an aliphatic linking group having from 1 to about 4 carbon atoms. An example of such an aromatic diisocyanate is methylendi(phenylisocyanate).
Methylendi(phenylisocyanate) is usually abbreviated with MDI.
MDI is selected from the group consisting of
   MDI-2-2, that is 2,2′-diphenylmethan-diisocyanate (CAS 2536-05-2), compound of formula (MDI-2-2),
   MDI-2-4, that is 2,4′-diphenylmethan-diisocyanate (CAS 5873-54-1), compound of formula (MDI-2-4),
   MDI-4-4, that is 4,4′-diphenylmethan-diisocyanate (CAS 101-68-8), compound of formula (MDI-4-4),
   and mixtures thereof;

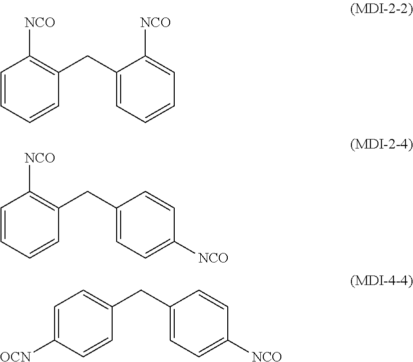

preferably MDI is a mixture of two of the mentioned isomers or a mixture of all three mentioned isomers.
MDI has a molecular weight of about 250.25 g/mol and an equivalent weight of about 125 g/mol.
Other aromatic diisocyanates, wherein the benzene rings are directly bonded to each other, are diisocyanates with a biphenyl moiety, such as compound of formula (BIPHEN);

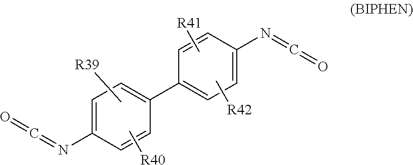

wherein
R39, R40, R41 and R42 are identical or different and independently from each other selected from the group consisting of H, F, Cl, Br, C₁₋₄ alkyl and C₁₋₄ alkoxy.
Preferably, R39, R40, R41 and R42 are identical or different and independently from each other selected from the group consisting of H, methyl and methoxy.
An embodiment of compound of formula (BIPHEN) is compound of formula (BIPHEN-X);

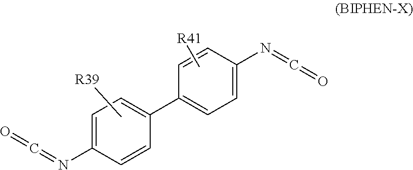

wherein
R39 and R41 are as defined herein, also with all their embodiments.
Examples for compound for formula (BIPHEN) are 4,4′-diisocyanato-1,1′-biphenyl, 4,4′-diisocyanato-3,3′-dimethyl-1,1′-biphenyl (molecular weight is about 264.09 g/mol; equivalent weight is about 132 g/mol), that is compound of formula (BIPHEN-1), and

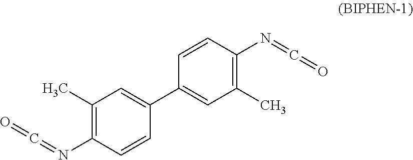 [SMILES: Cc1cc(-c2ccc(N=C=O)c(C)c2)ccc1N=C=O]

dianisidine diisocyanate (4,4′-diisocyanato-3,3′-dimethoxybiphenyl) (molecular weight is about 296 g/mol; equivalent weight is about 148 g/mol), that is compound of formula (DIANIS-1).

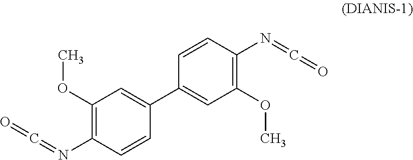 [SMILES: COc1cc(-c2ccc(N=C=O)c(OC)c2)ccc1N=C=O]

Certain commercially available aromatic diisocyanate comprise a single benzene ring. The isocyanate residues may be directly bonded to the benzene ring or may be linked through aliphatic groups having from 1 to about 4 carbon atoms. An example for such aromatic diisocyanate comprising a single benzene ring is compound of formula (PHEN);

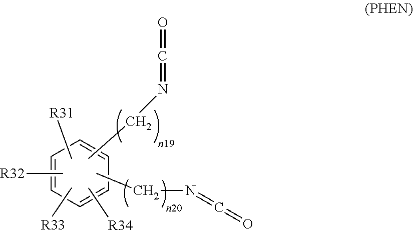

wherein
n19 and n20 are identical or different and independently from each 0, 1, 2, 3 or 4;
R31, R32, R33 and R34 are identical or different and independently from each selected from the group consisting of H, F, Cl, Br, C₁₋₄ alkyl and C₁₋₄ alkoxy.
Preferably, n19 and n20 are identical;
more preferably, n19 and n20 are 0.
Preferably, R31, R32, R33 and R34 are H or methyl.
Aromatic diisocyanates having a single benzene ring are for example ortho-, meta- and para-phenylene diisocyanate (molecular weight is about 160.1 g/mol; equivalent weight is about 80 g/mol), that is compound of formula (PHEN-O), compound of formula (PHEN-M) and compound of formula (PHEN-P)

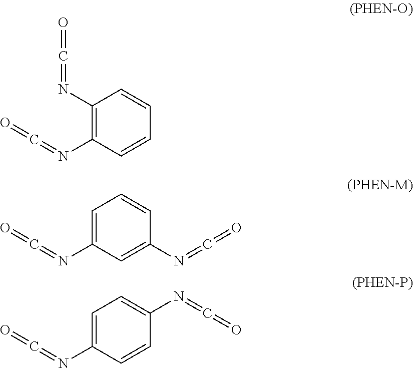

Other aromatic diisocyanates having a single benzene ring are toluene diisocyanates, toluene diisocyanates are usually abbreviated with TDI, preferred embodiments are 2,4-TDI with CAS 584-84-9 and 2,6-TDI with CAS 91-08-7 (both with molecular weight of about 174.2 g/mol; equivalent weight of about 85 g/mol), and 2,4,6-triisopropyl-m-phenylene isocyanate.
Similar diisocyanates having aliphatic groups linking the isocyanates to the benzene ring include 1,3-xylylene diisocyanate, 1,4-xylylene diisocyanate, tetramethyl-meta-xylylene diisocyanate, tetramethyl-para-xylylene diisocyanate, and meta-tetramethylxylene diisocyanate (1,3-bis(2-isocyanatopropan-2-yl) benzene).
Other aromatic diisocyanates comprise a naphtalene ring, an example of such an aromatic diisocyanate is 1,5-naphthylene diisocyanate.
Cycloaliphatic diisocyanate may include one or more cycloaliphatic rings having from 4 to about 7 carbon atoms. Typically, a cycloaliphatic ring is a cyclohexane ring. The one or more cyclohexane rings may be bonded directly to each other or through an aliphatic linking group having from 1 to 4 carbon atoms. Moreover, the isocyanate residues may be directly bonded to the cycloaliphatic ring or may be linked through an aliphatic group having from 1 to about 4 carbon atoms.
Typical cycloaliphatic diisocyanates are aromatic diisocyanates which have been hydrogenated, such as hydrogenated methylendi(phenylisocyanate), that is hydrogenated MDI. Such hydrogenated MDI is usually abbreviated with HMDI.
HMDI is selected from the group consisting of
   HMDI-2-2, that is compound of formula (HMDI-2-2),
   HMDI-2-4, that is compound of formula (HMDI-2-4),
   HMDI-4-4, that is compound of formula (HMDI-4-4),
   and mixtures thereof;

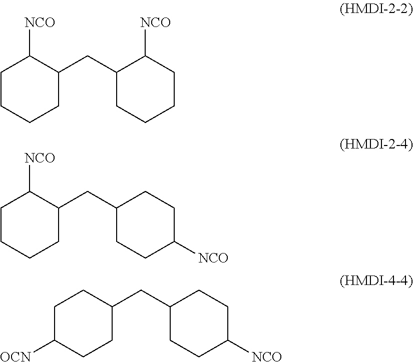

preferably HMDI is a mixture of two of the mentioned isomers or a mixture of all three mentioned isomers.
HMDI has a molecular weight of about 262 g/mol and an equivalent weight of about 131 g/mol.
HMDI-4-4 is also known as 4,4′-diisocyanatodicyclohexyl methane, bis(4-isocyanatocyclohexyl) methane or as Desmodur® W (Covestro).
Further cycloaliphatic diisocyanates are aromatic diisocyanate comprising a single benzene ring which have been hydrogenated and which therefore contain only one cyclohexene ring, such as hydrogenated compound of formula (PHEN), represented by compound of formula (HPHEN);

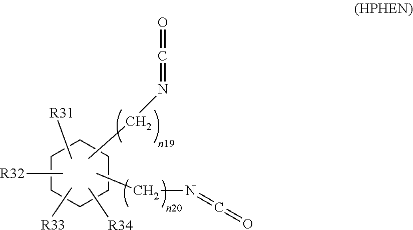

wherein
n19, n20, R31, R32, R33 and R34 as as defined herein, also with all their embodiments.
Examples of such aromatic diisocyanate comprising a single benzene ring which have been hydrogenated and which therefore contain only one cyclohexene ring, are hydrogenated ortho-, meta- and para-phenylene diisocyanate, that is compound of formula (CYCLHEX-O), compound of formula (CYCLHEX-M) and compound of formula (CYCLHEX-P).

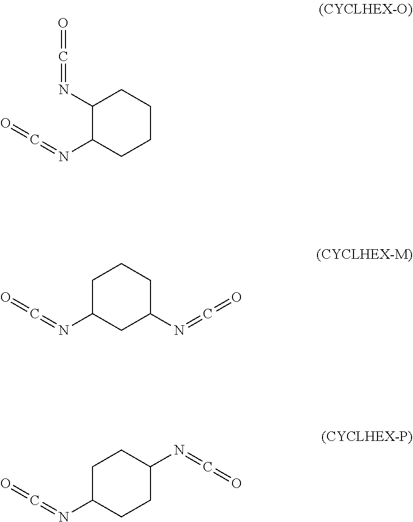 [SMILES: O=C=NC1CCCCC1N=C=O ; O=C=NC1CCCC(N=C=O)C1 ; O=C=NC1CCC(N=C=O)CC1]

Other aromatic diisocyanates having a single cyclohexene ring are hydrogentated toluene diisocyanates, hydrogentated toluene diisocyanates are usually abbreviated with HTDI, preferred embodiments are 2,4-HTDI and 2,6-HTDI, and 2,4,6-triisopropyl-m-cyclohexylene isocyanate.
Similar diisocyanates having aliphatic groups linking the isocyanates to the cyclohexene ring include hydrogenated 1,3-xylylene diisocyanate, hydrogenated 1,4-xylylene diisocyanate, hydrogenated tetramethyl-meta-xylylene diisocyanate, hydrogenated tetramethyl-para-xylylene diisocyanate, hydrogenated and meta-tetramethylxylene diisocyanate (1,3-bis(2-isocyanatopropan-2-yl) benzene).
Embodiments of diisocyanates with a single cyclohexylene ring are for example 1,4-cyclohexylene diisocyanate and 1-methyl-2,4-diisocyanatocyclohexane,
Further cycloaliphatic diisocyanates include 1,3-bis(isocyanatomethyl)cyclohexane and isophorone diisocyanate (also known as IPDI, 5-isocyanato-1-(isocyanatomethyl)-1,3,3-trimethylcyclohexane, that is compound of formula (IPDI)).

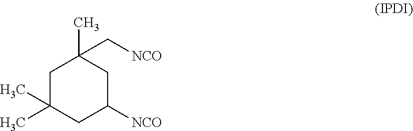

Certain aliphatic triisocyanates include, for example, trifunctional adducts derived from linear aliphatic diisocyanates. The linear aliphatic diisocyanate may be a compound of formula (XXI), with the compound of formula (XXI) as defined herein, also with all its embodiments; the trifunctional adduct can then be compound of formula (XXIII);

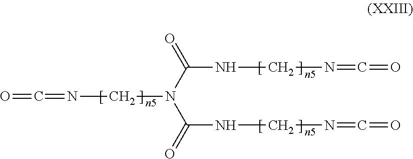

with n5 as defined herein, also with all its embodiments.
A particularly preferred compound of formula (XXI) useful for preparing aliphatic triisocyanates is hexamethylene-1,6-diisocyanate, and a particular preferred aliphatic triisocyanate is a trimer of hexamethylene-1,6-diisocyanate. The aliphatic triisocyanates may be derived from the aliphatic isocyanate alone, i.e., dimers, trimers, etc., or they may be derived from a reaction between the aliphatic isocyanate of structure (XXI), and a coupling reagent such as water or a low molecular weight triol, such as trimethylolpropane, trimethylolethane, glycerol or hexanetriol.
An exemplary aliphatic triisocyanate, wherein n5 is 6, is the biuret-containing adduct (i.e., trimers) of hexamethylene-1,6-diisocyanate, compound of formula (TRIISOCYAN-1).

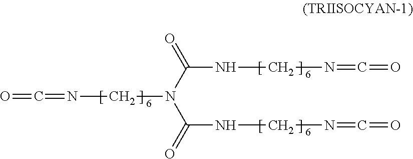

This material is available commercially under the trade name Desmodur N3200 (Covestro) or Tolonate HDB (Rhone-Poulenc). Desmodur N3200 has an approximate molecular weight of about 478.6 g/mole. The commercially available Desmodur N3200 has an approximate equivalent weight of about 191 g/mol (the theoretical equivalent weight is about 159 g/mol).
Another aliphatic triisocyanate derived from the aliphatic isocyanate of structure (XXI) is compound of formula (XXIV);

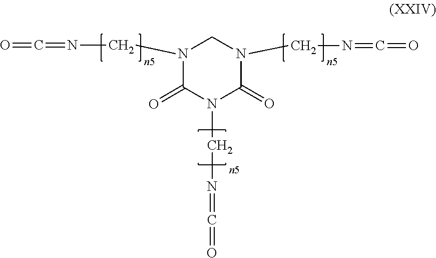

with n5 as defined herein, also with all its embodiments.

A specific compound of formula (XXIV) is compound of formula (TRIISOCYAN-2),

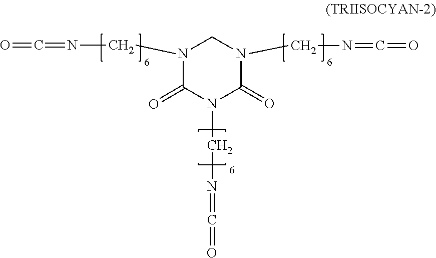

also having the name HDI isocyanurate trimer, which is available commercially under the trade names Desmodur N3300 (Covestro) or Tolonate HDT (Rhone-Poulenc).
Desmodur N3300 has an approximate molecular weight of about 504.6 g/mol, and an equivalent weight of about 168.2 g/mol.
Another exemplary aliphatic triisocyanate derived from the aliphatic isocyanate of structure (XXI) is compound of formula (XXV);

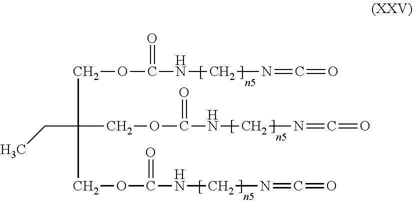 [SMILES: CCC(COC(=O)NCN=C=O)(COC(=O)NCN=C=O)COC(=O)NCN=C=O]

with n5 as defined herein, also with all its embodiments.
A specific compound of formula (XXV) is the triisocyanate adduct of trimethylolpropane and hexamethylene-1,6-diisocyanate, that is compound of formula (TRIISOCYAN-3).

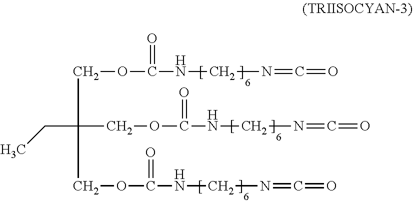 [SMILES: CCC(COC(=O)NCN=C=O)(COC(=O)NCN=C=O)COC(=O)NCN=C=O]

Compound of formula (XX) can also be a polymeric polyisocyanate. Example for such a polymeric polyisocyanate is polymeric methylendi(phenylisocyanate), which is usually abbreviated with PMDI and which can also be called polymethylene polyphenyl isocyanate.
PMDI can be represented by compound of formula (II).

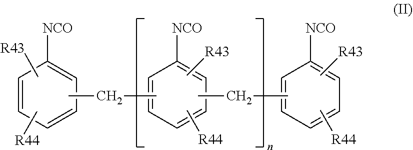

R43 and R44 are identical or different and independently from each other selected from the group consisting of H, C₁₋₄ alkyl, C₁₋₄ alkoxy, F, Cl and Br;
n is an integer from 1 to 500.
Preferably, R43 and R44 are identical or different and independently from each other selected from the group consisting of H and C₁₋₄ alkyl;
more preferably, R43 and R44 are identical or different and independently from each other selected from the group consisting of H and methyl;
even more preferably, R43 and R44 are H.
Preferably, n is an integer from 1 to 200, more preferably from 1 to 100, even more preferably from 1 to 50, especially from 1 to 25, more especially from 1 to 20, even more especially from 1 to 15, in particular from 1 to 10.
PMDI can be a compound with a specific, that is a discrete value of n, or PMDI is a mixture of compounds of formula (II) with different n values.
Compound of formula (XX) can also be an aromatic triisocyanate, an example for an aromatic triisocyanate is compound of formula (II) wherein n is 1; they are known under CAS 9016-87-9, an example is compound of formula (TRIISOCYAN-4).

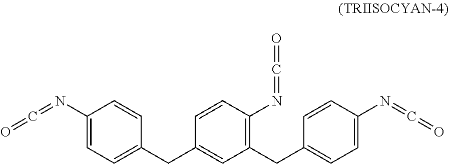 [SMILES: O=C=Nc1ccc(Cc2ccc(N=C=O)c(Cc3ccc(N=C=O)cc3)c2)cc1]

Isocyanates with an aromatic moiety may have a tendency to undergo in situ hydrolysis at a greater rate than aliphatic isocyanates. Since the rate of hydrolysis is decreased at lower temperatures, isocyanate reactants are preferably stored at temperatures no greater than about 50° C., and isocyanate reactants containing an aromatic moiety are preferably stored at temperatures no greater than from about 20 to about 25° C., and under a dry atmosphere.
Still other polyisocyanates include toluene diisocyanate adducts with trimethylolpropane, xylene diisocyanate and polymethylene polyphenyl polyisocyanate-terminated polyols.
Preferably, ISOCYAN is selected from the group consisting of compound of formula (XXI), compound of formula (XXII), methylendi(phenylisocyanate), compound of formula (BIPHEN), compound of formula (PHEN), 1,5-naphthylene diisocyanate, hydrogenated methylendi(phenylisocyanate), compound of formula (HPHEN), compound of formula (XXIII), compound of formula (XXIV), compound of formula (XXV), and polymeric methylendi(phenylisocyanate), and mixtures thereof;
with
compound of formula (XXI), compound of formula (XXII), methylendi(phenylisocyanate), compound of formula (BIPHEN), compound of formula (PHEN), 1,5-naphthylene diisocyanate, hydrogenated methylendi(phenylisocyanate), compound of formula (HPHEN), compound of formula (XXIII), compound of formula (XXIV), compound of formula (XXV), and polymeric methylendi(phenylisocyanate) as defined herein, also with all their embodiments.
ISOCYAN is preferably selected from the group consisting of methylendi(phenylisocyanate), polymeric methylendi(phenylisocyanate), hydrogenated methylendi(phenylisocyanate), isophoron diisocyanate, hexamethylene diisocyanate, toluene diisocyanate, and mixtures thereof;
with methylendi(phenylisocyanate), polymeric methylendi(phenylisocyanate), hydrogenated methylendi(phenylisocyanate), isophoron diisocyanate, hexamethylene diisocyanate, and toluene diisocyanate as described herein, also with all their embodiments.
Preferably, the polyalcohol is a polyalcohol ALC;
ALC in the sense of the invention is a compound that contains two or more hydroxy residues per molecule.
ALC is selected from the group consisting of polyvinylalcohol, poly (ethylene glycol), poly (propylene glycol), poly (ethylene glycol)-block-poly (propylene glycol), poly (ethylene glycol)-block-poly (propylene glycol)-block-poly (ethylene glycol), ethylene glycol, propylene glycol, compound of formula (X), and mixtures thereof,

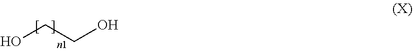

wherein
n1 is in integer from 1 to 9.
Preferably, n1 is 1, 2, 3, 4 or 5.
Preferably, ALC is selected from the group consisting of polyvinylalcohol, poly (ethylene glycol)-block-poly (propylene glycol)-block-poly (ethylene glycol), compound of formula (X) with n1 being 1, 2 or 3, and mixtures thereof.
Polyvinylalcohol is usually abbreviated with PVA.
Preferably, PVA has a molecular weight of from 20′000 to 40′000 g/mol.
Poly (ethylene glycol) is usually abbreviated with PEG, poly (propylene glycol) is usually abbreviated with PPG.
A poly (ethylene glycol)-block-poly (propylene glycol) is usually abbreviated with PEG-PPG.
A poly (ethylene glycol)-block-poly (propylene glycol)-block-poly (ethylene glycol) is usually abbreviated with PEG-PPG-PEG.
PEG, PPG, PEG-PPG and PEG-PPG-PEG can have an average molecular weight of 5′000 to 6′500 g/mol.
Preferably, the polyamine is a polyamine AMI;
AMI in the sense of the invention is a compound that contains two or more amino residues per molecule.
Preferably, COMPOHNH is selected from the group consisting of ALC, water, AMI, and mixtures thereof.
Preferably, AMI is selected from the group consisting of compound of formula (XI), compound of formula (XIV), compound of formula (XII), compound of formula (XXVII), polymeric methylendi(aniline), hydrogenated methylendi(aniline), cystamine, triethylene glycol diamine, compound of formula (XVII), compound of formula (XXVI), and mixtures thereof;

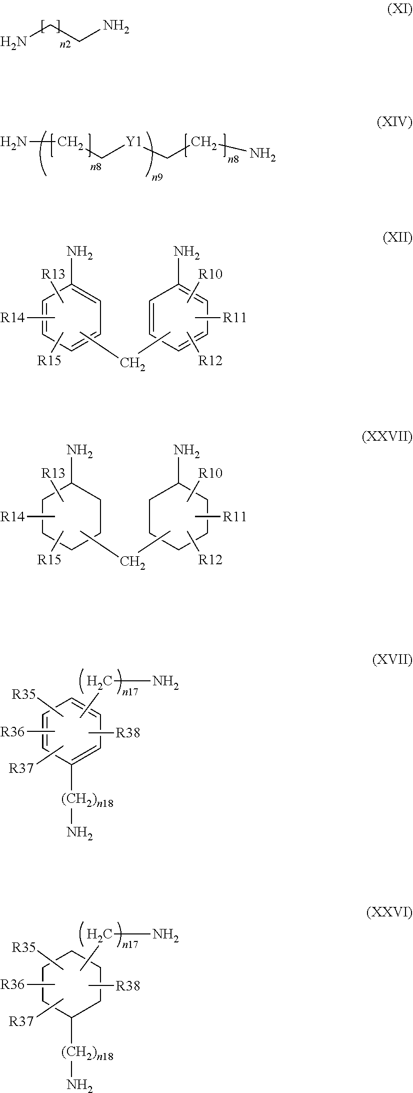

wherein
n2 is in integer from 1 to 9;
R10, R11, R12, R13, R14, R15, R35, R36, R37 and R38 are identical or different and are independently from each other selected from the group consisting of H, halogen, and C₁₋₄ alkyl;
n8 is an integer from 1 to 5, preferably from 0, 1, 2 or 3;
n9 is 1, 2, 3, 4, 5, 6 or 7;
Y1 is selected from the group consisting of S—S, (CH₂)ₙ₆—Z1-(CH₂)ₙ₆, and
Z1-(CH₂)ₙ₂—Z1;
n6 is 0, 1, 2, 3 or 4, preferably from 0, 1, 2 or 3;
Z1 is selected from the group consisting of NH, O, and S;
n17 and n18 are identical or different and are independently from each other an integer number selected from the group consisting of 0, 1, 2, 3 and 4.
Halogen is preferably Cl; Br, F or I.
Preferably, n2 is 1, 2, 3, 4, 5, 6, 7, 8 or 9;
more preferably, n2 is 1, 2, 3, 4, 5, 6, 7 or 8, even more preferably from 2, 3, 4, 5 or 6, especially from 2, 3, 4 or 5.
Preferably, R10, R11, R12, R13, R14, R15, R35, R36, R37 and R38 are identical or different and are independently from each other selected from the group consisting of H, F, Cl, methyl, ethyl and propyl.
Preferably, compound of formula (XIV) are polyethylene amines, for example selected from the group consisting of amines of the structure NH₂(CH₂CH₂NH)ₙ₇CH₂CH₂NH₂, as well as substituted and unsubstituted polypropylene imines;
wherein
n7 is an integer from 1 to 5, preferably from 1 to 5, more preferably n7 is 1, 2 or 3.
Further examples for AMI are diethylene triamine (molecular weight of about 103.17 g/mol, equivalent weight of about 34.4 g/mol), triethylene tetramine (molecular weight of about 146.23 g/mol, equivalent weight of about 36.6 g/mol), iminobispropylamine, and bis(hexamethylene) triamine, triethylene glycol diamine (which is e.g. Jeffamine EDR-148 from Huntsman Corp., Houston, Tex., with CAS 929-59-9, compound of formula (JEFFAM)).

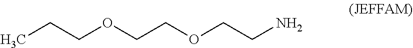

Preferably, compound of formula (XII) is selected from the group consisting of compound of formula (XII-1), compound of formula (XII-2), compound of formula (XII-3), compound of formula (XII-4), compound of formula (XII-5), compound of formula (XII-6), compound of formula (XII-7), compound of formula (XII-8), and mixtures thereof.

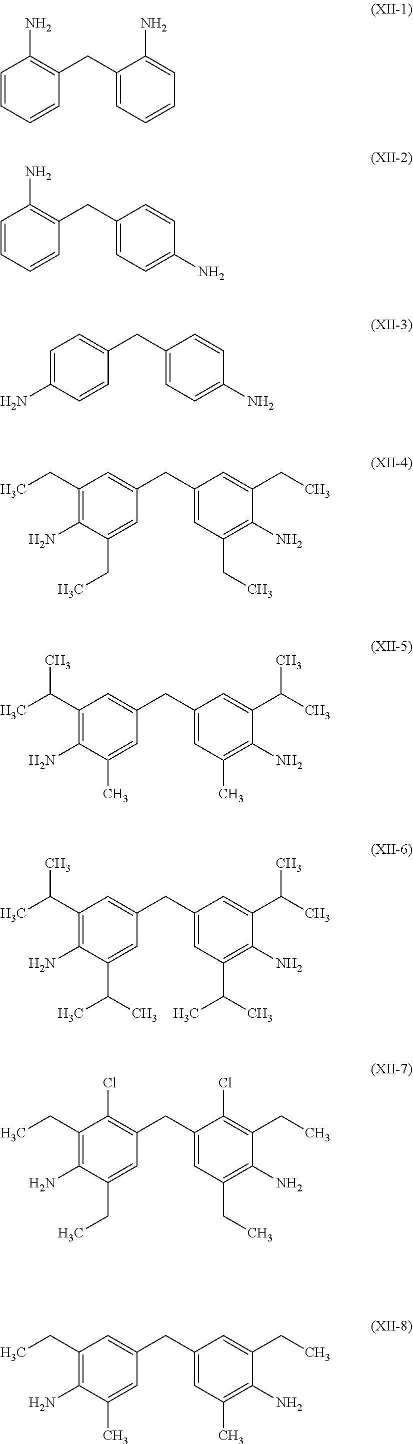

More preferably, compound of formula (XII) is selected from the group consisting of compound of formula (XII-1), compound of formula (XII-2), compound of formula (XII-3), compound of formula (XII-4), compound of formula (XII-5), compound of formula (XII-6), and mixtures thereof.
Preferably, compound of formula (XXVII) is selected from the group consisting of compound of formula (XXVII-1), compound of formula (XXVII-2), compound of formula (XXVII-3), compound of formula (XXVII-4), compound of formula (XXVII-5), compound of formula (XXVII-6), compound of formula (XXVII-7), compound of formula (XXVII-8), and mixtures thereof.

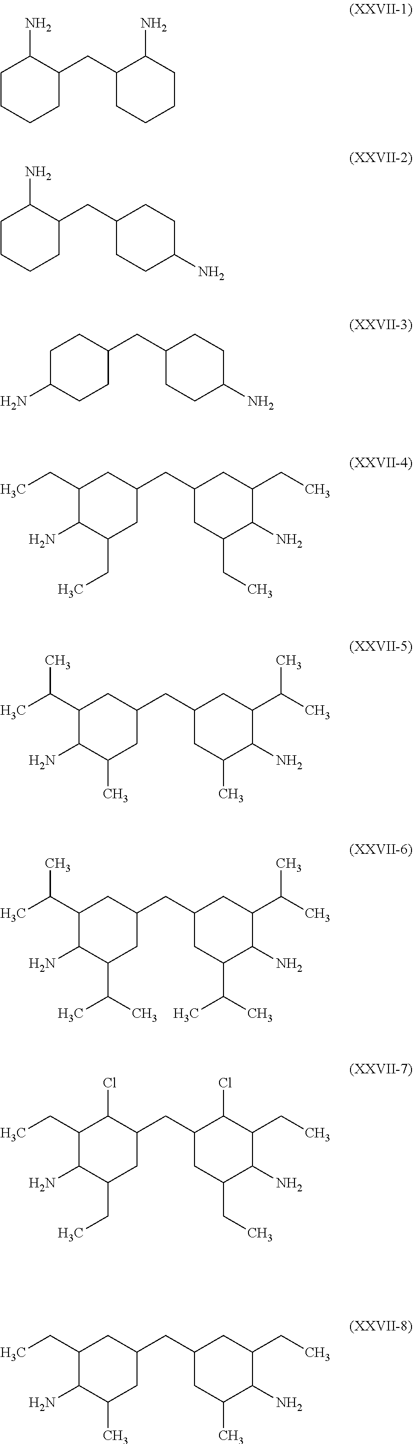

More preferably, compound of formula (XXVII) is selected from the group consisting of compound of formula (XXVII-1), compound of formula (XXVII-2), compound of formula (XXVII-3), compound of formula (XXVII-4), compound of formula (XXVII-5), compound of formula (XXVII-6), and mixtures thereof
Polymeric methylendi(aniline) can be represented by compound of formula (XIII).

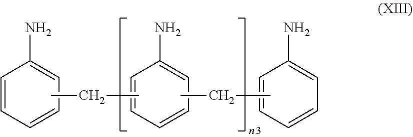

n3 is an integer from 1 to 500, preferably, from 1 to 200, more preferably from 1 to 100, even more preferably from 1 to 50, especially from 1 to 25, more especially from 1 to 20, even more especially 1 to 15, in particular 1 to 10.
Polymeric methylendi(aniline) can a be compound with a specific, that is a discrete value of n3, or polymeric methylendi(aniline) is a mixture of compounds of formula (XIII) with different n3 values.
Preferably, n17 and n18 are independently from each other 0 or 1, more preferably n17 and n18 are 0.
Examples for compound of formula (XVII) are meta-xylylene diamine with CAS 1477-55-0, e.g. from Mitsubishi Gas Co., Tokyo, JP (molecular weight of about 136.19 g/mol; equivalent weight of about 68.1 g/mol), para-xylylenediamine, 2,3,5,6-tetramethyl-1,4-xylylenediamine, 2,5-dimethyl-1,4-xylylenediamine, compound of formula (XVIII), compound of formula (XIX), of which diethyl toluene diamine is an embodiment, such as with CAS 68479-98-1, compound of formula (DETDA), and compound of formula (DETDA-Cl);

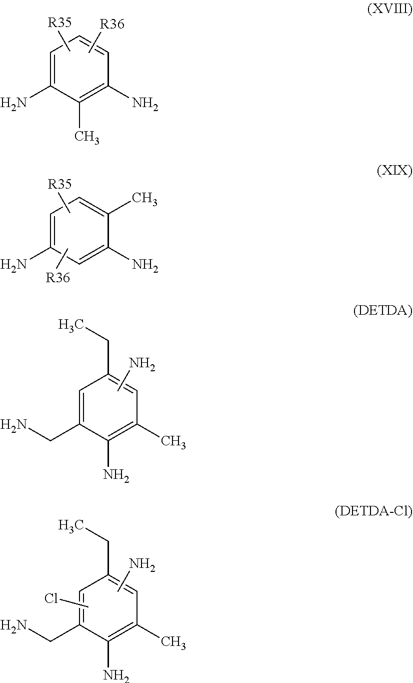

wherein
R35 and R36 are identical or different and are H, Cl or C₁₋₄ alkyl, preferably H, methyl or ethyl, more preferably methyl or ethyl.
Examples for compound of formula (XXVI) are isophoron diamine, hydrogenated meta-xylylene diamine, hydrogenated para-xylylenediamine, hydrogenated 2,3,5,6-tetramethyl-1,4-xylylenediamine, hydrogenated 2,5-dimethyl-1,4-xylylenediamine, compound of formula (XXVIII), compound of formula (XXIX), of which hydrogenated diethyl toluene diamine is an embodiment, compound of formula (HDETDA), and compound of formula (HDETDA-Cl);

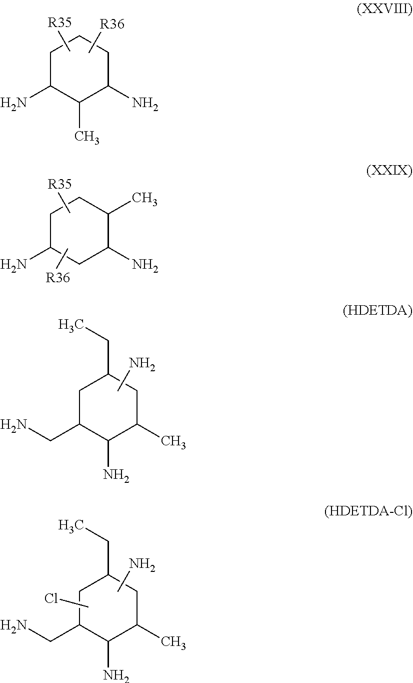

wherein
R35 and R36 are identical or different and are H, Cl or C₁₋₄ alkyl, preferably H, methyl or ethyl, more preferably methyl or ethyl.
More preferable, AMI is selected from the group consisting of compound of formula (XI), compound of formula (XII), polymeric methylendi(aniline), hydrogenated methylendi(aniline), isophoron diamine, compound of formula (XVII), compound of formula (XXVI), and mixtures thereof;
with compound of formula (XI), compound of formula (XII), polymeric methylendi(aniline), hydrogenated methylendi(aniline), isophoron diamine, compound of formula (XVII) and compound of formula (XXVI) as defined herein, also with all their embodiments.
POLYUREAPOLYM can also be made by polymerization of ISOCYAN with AMI.
The polymerization POLYM, that provides the polyurea, be it a polymerization of ISOCYAN in the presence of water, or be it a polymerization of ISOCYAN with AMI, or be it a combination thereof, can be done in the presence of an auxiliary amine AUXAMI.
The presence of AUXAMI can be used for example to modify the permeability MICROENCAPSMAT, that is the permeability of the shell or wall of the MICROCAPS, and thereby the release rate of BIOC may be affected; for example, by varying the relative amounts of the amines used in the shell- or wall-forming polymerization.
This permeability, or release rate, may change (e.g. increase) as the ratio of AUXAMI to AMI increases. It is to be noted, however, that alternatively or additionally the rate of permeability may be further optimized by altering the shell wall composition, that is the composition of MICROENCAPSMAT, by for example, (i) the type of isocyanate employed, (ii) using a blend of isocyanates, (iii) using an AMI having the appropriate hydrocarbon chain length between the amino groups, and/or (iv) varying the ratios of the shell wall components and BIOC, all as determined, for example, experimentally using means standard in the art.
In some embodiments, AUXAMI may be a polyalkyleneamine prepared by reacting an alkylene oxide with a diol or triol to produce a hydroxyl-terminated polyalkylene oxide intermediate, followed by amination of the terminal hydroxyl groups.
Alternatively, AUXAMI may be a polyether amine (alternatively termed a polyoxyalkylene amine, such as for example polyoxypropylene tri- or diamine, and polyoxyethylene tri- or diamine), being a compound of formula (XVI);

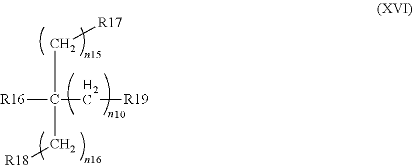

wherein
n10, n15 and n16 are identical or different and independently from each other 0 or 1;
R16 is selected from the group consisting of hydrogen and CH₃—(CH₂)ₙ₁₁;
n11 is 0, 1, 2, 3, 4 or 5;
R17 and R18 are identical or different and independently from each other

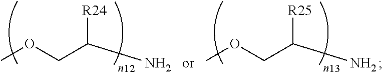

R19 is hydrogen or

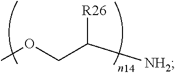

R24, R25 and R26 are identical or different and independently from each other selected from the group consisting of hydrogen, methyl, and ethyl;
n12, n13 and n14 are identical or different and independently from each a number from 2 to 40, preferably from 5 to 30, more preferably from 10 to 20.
In some embodiments, the value of sum n12+n13+n14 is preferably no more than about 20, more preferably no more than about 15 and even more preferably no more than about 10. Examples of AUXAMI having the formula (XVI) include amines of the Jeffamine ED series (Huntsman Corp., Houston, Tex.). One of such preferred AUXAMI is Jeffamine T-403 (Huntsman Corp., Houston, Tex.) with CAS 39423-51-3, which is a compound of formula (XVI) wherein n10, n15 and n16 are 1, n11 is 1, R19 is not hydrogen, the sum n12+n13+n14 is 5 or 6, R24, R25 and R25 are methyl.
The reaction of a polyfunctional amine with an epoxy functional compound has been found to produce epoxy-amine adducts which are also useful as AUXAMI. So AUXAMI can be an epoxy-amine adduct.
Epoxy-amine adducts are generally known in the art (see, e.g., Lee, Henry and Neville, Kris, Aliphatic Primary Amines and Their Modifications as Epoxy-Resin Curing Agents in Handbook of Epoxy Resins, pp. 7-1 to 7-30, McGraw-Hill Book Company (1967).) Preferably, the adduct has a water solubility. Preferably, the polyfunctional amine which is reacted with an epoxy functional compound to form the adduct is an amine as previously set forth above. More preferably, the polyfunctional amine is diethylenetriamine or ethylene diamine. Preferred epoxy functional compounds include ethylene oxide, propylene oxide, styrene oxide, and cyclohexane oxide. Also diglycidyl ether of bisphenol A (CAS 1675-54-3) is a useful adduct precursor when reacted with an amine, preferably in an amine to epoxy group ratio of at least about 3 to 1.
It is to be noted, however, that permeability may also be decreased in some instances by the addition of an AUXAMI. For example, it is known that the selection of certain ring-containing amines as AUXAMI is useful in providing microcapsules with release rates which decrease as the amount of such AUXAMI increases relative to AMI. Preferably, AUXAMI is a compound selected from the group consisting of cycloaliphatic amines and arylalkyl amines. Aromatic amines, or those having the nitrogen of an amine residue bonded to a carbon of the aromatic ring, may not be universally suitable. Exemplary, and in some embodiments preferred, cycloaliphatic amines include 4,4′-diaminodicyclohexyl methane, 1,4-cyclohexanebis(methylamine) and isophorone diamine (molecular weight of about 170.30 g/mol; equivalent weight of about 85.2 g/mol). An exemplary, and in some embodiments preferred, arylalkyl amine is compound of formula (XVII), with compound of formula (XVII) as defined above, also with all its embodiments.
Preferably, AMI and optional AUXAMI have at least about two amino residues or functionalities, more preferably 2 or 3 or 4. Without being held to any particular theory, it is generally believed that in POLYM as described herein, the effective functionality of a polyfunctional amine is typically limited to 2 or higher and 4 or lower. This is believed to be due to steric factors, which normally prevent significantly more than about 3 amino residues in the polyfunctional amine from participating in the polymerization reaction.
It is to be further noted that the molecular weight of AMI and AUXAMI, is preferably less than about 1000 g/mol, and in some embodiments is more preferably less than about 750 g/mol or even 500 g/mol. For example, the molecular weight of AMI and AUXAMI may range from about 75 g/mol to about 750 g/mol, or from about 100 g/mol to about 600 g/mol, or from about 150 g/mol to about 500 g/mol. Equivalent weights (the molecular weight divided by the number of amine functional residues) generally range from about 20 g/mol to about 250 g/mol, such as from about 30 g/mol to about 125 g/mol. Without being held to a particular theory, it is generally believed that steric hindrance is a limiting factor here, given that bigger molecules may not be able to diffuse through the early-forming proto-shell wall to reach, and react to completion with, an isocyanate monomer in the core during polymerization.
Preferably, MICROCAPS comprises from 80 to 100 wt %, more preferably from 85 to 100 wt %, even more preferably from 90 to 100 wt %, especially from 95 to 100 wt %, more especially from 97.5 to 100 wt %, of the combined amounts of BIOC and MICROENCAPSMAT, the wt % being based on the total weight of MICROCAPS.
Preferably, MICROCAPS comprises from 10 to 80 wt %, more preferably from 10 to 70 wt %, even more preferably from 10 to 60 wt %, especially even more preferably from 10 to 50 wt %, of BIOC, the wt % being based on the total weight of MICROCAPS.
Preferably, MICROCAPS comprises from 20 to 95 wt %, more preferably from 30 to 90 wt %, even more preferably from 40 to 90 wt %, more preferably from 50 to 90 wt %, even more preferably from 60 to 90 wt %, of MICROENCAPSMAT, the wt % being based on the total weight of MICROCAPS.
Preferably, the weight ratio (w/w) MICROENCAPSMAT:BIOC in MICROCAPS is from 1:1 to 10:1, more preferably from 1:1 to 7:1, even more preferably from 1:1 to 5:1.
MICROENCAPSMAT can comprises a polyurethane polymer POLYURETHPOLYM.
Preferably, MICROENCAPSMAT can comprise up to 20 wt %, more preferably up to 10 wt %, even more preferably up to 5 wt %, of POLYURETHPOLYM, the wt % being based on the amount of POLYUREAPOLYM;
preferably MICROENCAPSMAT can comprise from 0.001 to 20 wt %, more preferably from 0.001 to 10 wt %, even more preferably from 0.001 to 5 wt %, of POLYURETHPOLYM, the wt % being based on the amount of POLYUREAPOLYM.
In another embodiment, preferably MICROENCAPSMAT can comprise from 0.01 to 20 wt %, more preferably from 0.01 to 10 wt %, even more preferably from 0.01 to 5 wt %, of POLYURETHPOLYM, the wt % being based on the amount of POLYUREAPOLYM.
In another embodiment, preferably MICROENCAPSMAT can comprise from 0.1 to 20 wt %, more preferably from 0.1 to 10 wt %, even more preferably from 0.1 to 5 wt %, of POLYURETHPOLYM, the wt % being based on the amount of POLYUREAPOLYM;
POLYURETHPOLYM is preferably made by polymerization of ISOCYAN with a polyalcohol, that is preferably POLYM is done in the presence of a polyalcohol;
preferably, the polyalcohol is ALC, with ALC as defined herein, also with all its embodiments.
METHENCAPS can be done in the presence of a polyalcohol;
preferably, the polyalcohol is ALC, with ALC as defined herein, also with all its embodiments.
METHENCAPS and/or POLYM can be done in the presence of a catalyst CAT.
MICROCAPS can, besides BIOC and MICROENCAPSMAT, further comprise CAT.
CAT may be selected from the group consisting of DABCO, dimethylcyclohexylamine, dimethylethanolamine, triethylenediamine, N,N,N′,N″,N″-pentamethyldiethylenetriamine, 1,2-dimethylimidazol, N,N,N′,N′-tetramethyl-1,6-hexanediamine, N,N′,N′-trimethylaminoethylpiperazine, 1,1′-[[3-(dimethyl amino)propyl]imino]bispropane-2-ol, N,N,N′-trimethylaminoethylethanolamine, and N,N′,N″-tris(3-dimethylaminopropyl)-hexahydro-s-triazine.
Preferably, CAT is DABCO or triethylenediamine.
More preferably, CAT is DABCO.
CAT is used during METHENCAPS and/or POLYM which preferably takes place in aqueous medium, therefore CAT can remain in solution if its water solubility is sufficient. It is not intended that CAT is part of MICROCAPS. But it is possible that part or all of CAT can be comprised in MICROCAPS, for example when, in spite of the water solubility of CAT, CAT is adsorbed by the MICROCAPS.
Therefore, MICROCAPS can comprise part of all of the amount of CAT that was used in the preparation of MICROCAPS, MICROCAPS therefore can comprise up to 10 wt %, more preferably up to 7.5 wt %, even more preferably up to 5 wt %, of CAT, the wt % being based on the amount of POLYUREAPOLYM;
preferably MICROCAPS therefore can comprise from 0.001 to 10 wt %, more preferably from 0.001 to 7.5 wt %, even more preferably from 0.001 to 5 wt %, of CAT, the wt % being based on the amount of POLYUREAPOLYM;
any of these values are also indications of the possible amounts of CAT which may be present in METHENCAPS.
Therefore in another embodiment, MICROCAPS can comprise part of or all the amount of CAT that was used in the preparation of MICROCAPS, preferably MICROCAPS comprises up to 5 wt %, more preferably up to 4 wt %, even more preferably up to 3.5 wt %, of CAT, the wt % being based on the amount of the total weight of MICROCAPS;
preferably MICROCAPS comprises from 0.001 to 5 wt %, more preferably from 0.001 to 4 wt %, even more preferably from 0.001 to 3.5 wt %, of CAT, the wt % being based on the amount of the total weight of MICROCAPS;
any of these values are also indications of the possible amounts of CAT which may be present in METHENCAPS.
METHENCAPS can be done in the presence of an additive ADDIT.
MICROCAPS can, besides BIOC and MICROENCAPSMAT, further comprise one or more additives ADDIT, which can be present in the preparation of MICROCAPS;
ADDIT is selected from the group consisting of Gum Arabic, ALC, polyacrylate, unsaponified or partially saponified polyvinyl acetate, polyvinylpyrrolidone, cellulose ether, starch, proteins, alginates, pectins, gelatins, polysaccharides, sodium or magnesium silicates, carboxymethylcellulose, acrylates and acrylic polymers, acrylate/aminoacrylate copolymers, arabinogalactan, carageenan, water-swellable clays, maltodextrin, natural gums, protein hydrolysates and their quaternized forms, poly(vinyl pyrrolidone-covinyl acetate), poly(vinyl alcohol-co-vinyl acetate), poly(maleic acid), maleic-vinyl copolymers, poly(alkyleneoxide), poly(vinylmethylether), poly(vinylether-co-maleic anhydride), poly(ethyleneimine), poly((meth)acrylamide), poly(alkyleneoxide-co-dimethylsiloxane), poly(amino dimethylsiloxane), sodium lignosulfonates, maleic anhydride/styrene copolymers, ethylene/maleic anhydride copolymers, copolymers of ethylene oxide, propylene oxide and ethylenediamine, fatty acid esters of polyethoxylated sorbitol, and sodium dodecylsulfate;
with ALC as defined herein, also with all its embodiments.
Natural gums are for example xanthan gum, gellan gum, guar gum and alginate esters.
Polyacrylate can be an acrylic copolymer potassium salt.
Cellulose ether can be tylose, methylcellulose, hydroxyethylcellulose or hydroxypropylmethylcellulose.
Preferably, ADDIT is selected from the group consisting of Gum Arabic, ALC, polyacrylate, unsaponified or partially saponified polyvinyl acetate, polyvinylpyrrolidone, cellulose ether, starch, alginates, pectins, gelatins, polysaccharides, xanthan gum, sodium or magnesium silicates, carboxymethylcellulose, and polyacrylic acids;
more preferably, ADDIT is selected from the group consisting of Gum Arabic, ALC, polyacrylate, and polyvinylpyrrolidone;
even more preferably, ADDIT is selected from the group consisting of Gum Arabic and ALC;
with ALC as defined herein, also with all its embodiments.
ADDIT is used during the METHENCAPS which preferably takes place in aqueous medium, therefore ADDIT can remain in solution if its water solubility is sufficient. It is not intended that ADDIT are part of MICROCAPS. In case that ADDIT is ALC and POLYM is done in the presence of ALC, then during polymerization it is possible that part or all of ALC reacts with ISOCYAN, thereby providing POLYURETHPOLYM, which is rather insoluble in water and will thereby be comprised in the MICROENCAPSMAT. In case that ALC is present in POLYM, ALC can also with an isocyanate residue of POLYUREAPOLYM and thereby provide for a polyurethane-polyurea polymer in MICROENCAPSMAT. Also the other mentioned ADDIT, such as the Gum Arabic, can be comprised in MICROCAPS, for example when in spite of any water solubility they are adsorbed by the MICROCAPS.
Therefore, MICROCAPS can comprise part of or all of the amount of ADDIT that was used in the preparation of MICROCAPS, preferably MICROCAPS can comprise up to 10 wt %, more preferably up to 7.5 wt %, even more preferably up to 6 wt %, especially up to 5 wt %, of ADDIT, the wt % being based on the amount of POLYUREAPOLYM;
preferably MICROCAPS can comprise from 0.001 to 10 wt %, more preferably from 0.01 to 7.5 wt %, even more preferably from 0.01 to 6 wt %, especially from 0.01 to 5 wt %, of ADDIT, the wt % being based on the amount of POLYUREAPOLYM;
any of these values are also indications of the possible amounts of ADDIT which may be present in METHENCAPS.
Therefore in another embodiment, MICROCAPS can comprise part of or all of the amount of ADDIT that was used in the preparation of MICROCAPS, preferably MICROCAPS comprises up to 5 wt %, more preferably up to 4 wt %, even more preferably up to 3.5 wt %, of ADDIT, the wt % being based on the amount of the total weight of MICROCAPS;
preferably MICROCAPS comprises from 0.001 to 5 wt %, more preferably from 0.01 to 4 wt %, even more preferably from 0.01 to 3.5 wt %, of ADDIT, the wt % being based on the amount of the total weight of MICROCAPS;
any of these values are also indications of the possible amounts of ADDIT which may be present in METHENCAPS.
In an embodiment of the invention, MICROCAPS consists of BIOC and of MICROENCAPSMAT, and optionally of CAT and optionally of ADDIT, with the amounts of BIOC and of MICROENCAPSMAT, and optionally of CAT and optionally of ADDIT as defined herein, also with all their embodiments, and with the amounts of BIOC, MICROENCAPSMAT, CAT and ADDIT adding up to 100 wt %, the wt % being based on the total weight of MICROCAPS
In a preferable embodiment of the invention, MICROCAPS consists of BIOC and MICROENCAPSMAT, with the amounts of BIOC and MICROENCAPSMAT as defined herein, also with all their embodiments, and with the amounts of BIOC and MICROENCAPSMAT adding up to 100 wt %, the wt % being based on the total weight of MICROCAPS
POLYM can be done in the presence of ALC, in this case POLYURETHPOLYM is formed.
So POLYM can also be any combination of a polymerization of ISOCYAN in the presence of water and of a polymerization of ISOCYAN with AMI and optionally of a polymerization of ISOCYAN with ALC.
Preferably, POLYM is done in the presence of water.
The mechanism of POLYM in case that POLYM is done in the presence of water is known: POLYM of ISOCYAN can be started by the water, which reacts with an isocyanate residue of ISOCYAN, by this reaction this isocyanate residue is converted to an amino residue, this amino residue then reacts with another isocyanate residue of another ISOCYAN forming a urea derivative; this urea derivative still has at least one isocyanate residue which again can react either with water to provide for another amino residue which then can react with another isocyanate residue, of this at least one isocyanate residue can react with an amino residue which was provide by a reaction of another isocyanate residue with water.
POLYM, which is done in the presence of water or which is done in the presence of AMI, provides POLYUREAPOLYM in MICROENCAPSMAT.
In case that ALC is present in POLYM, the ALC can react with ISOCYAN or with an isocyanate residue of POLYUREAPOLYM and thereby provide for POLYURETHPOLYM or for a polyurethane-polyurea polymer respectively in MICROENCAPSMAT.
Preferably, POLYM is done in the presence of a solvent SOLVOIL, SOLVOIL is selected from the group consisting of ethyl acetate, xylene, MTBE, and toluene; preferably, SOLVOIL is ethyl acetate or toluene.
Preferably, BIOC is used in powder form.
Preferably, BIOC in present in POLYM in form of a suspension.
Preferably, the volume averaged particle size of BIOC is smaller than 100 micrometer, more preferably is smaller 40 micrometer.
Preferably, BIOC has a D10 value of smaller than 10 micrometer, more preferably of smaller than 5 micrometer.
Preferably, BIOC has a D50 value of smaller than 20 micrometer, more preferably of smaller than 16 micrometer.
Preferably, BIOC has a D90 value of smaller than 40 micrometer, more preferably of smaller than 35 micrometer, even more preferably of smaller than 30 micrometer.
Preferably, POLYM is done in an emulsion, more preferably in an O/W emulsion OWE or in a W/O/W emulsion WOWE.
Any emulsion and any suspension used in POLYM can be prepared according to methods known to the person skilled in the art, such as by application of shear and mixing force, which may be applied by the use of respective stirring, mixing or dispersion means, such as high shear mixers, for example Ultra Turrax, mills, for example bead mills, use of ultrasonic sound waves and the like, be the application batch wise or inline, that is continuously.
More preferably, METHENCAPS comprises a step STEP1 and a step STEP3;
STEP1 comprises the preparation of OWE,
OWE is prepared by mixing a water phase WP1 and an oil phase;
STEP3 comprises POLYM.
The solvent of the oil phase of OWE is SOLVOIL.
In another more preferred embodiment, METHENCAPS comprises STEP1, a step STEP2 and STEP3;
STEP2 comprises the preparation of WOWE,
WOWE is prepared by mixing a water phase WP2 with OWE;
with STEP1 and STEP3 as defined herein, also with all their embodiments.
OWE is prepared in STEP1.
When POLYM is done in OWE, then POLYM does not comprise STEP2.
When POLYM is done in WOWE, then POLYM does comprises STEP2.
Preferably, the amount of ISOCYAN in POLYM is from 1 to 10 times, more preferably from 1 to 5 times, even more preferably from 1.5 to 5 times, especially from 1.5 to 2.5 times, of the weight of BIOC.
Preferably, the amount of water in POLYM is at least 0.5 molar equivalents to the molar amount of the isocyanate residues of ISOCYAN; preferably the amount of water in POLYM is from 1 to 20 times, more preferably from 2 to 15 times, even more preferably from 5 to 12.5 times, of the weight of ISOCYAN.
Preferably, the amount of SOLVOIL in POLYM is from 0.5 to 5 times, preferably from 0.5 to 3 times, even more preferably from 0.5 to 2 times, especially from 0.6 to 1.8 times, of the weight of ISOCYAN.
Preferably, ISOCYAN is used in POLYM in form of a solution in SOLVOIL.
POLYM can be done in the presence of CAT, with CAT as defined herein, also with all its embodiments.
CAT can be present in POLYM in an amount of from 1 to 10 wt %, preferably of from 2 to 9 wt %, even more preferably of from 3 to 8.5 wt %, especially of from 4 to 8 wt %, the wt % being based in the weight of ISOCYAN.
Preferably, ISOCYAN is dissolved in the SOLVOIL that provides the oil phase of OWE.
Preferably, BIOC is used in POLYM either in form of a mixture of BIOC with water or with SOLVOIL. BIOC is used in form of a suspension in water or in SOLVOIL. Preferably, the water that is used for the preparation of said mixture of BIOC with water is the water that provides for WP1, the SOLVOIL that is used for the preparation of said mixture of BIOC with SOLVOIL is preferably the SOLVOIL that provides for the oil phase of OWE or of WOWE.
In case of BIOC being Diuron, the Diuron is preferably provided as a suspension either in the water that provides for WP1, or in the SOLVOIL that provides for the oil phase of OWE or of WOWE.
Preferably, CAT is present in POLYM in form of an aqueous solution or in form of an aqueous suspension. Preferably, CAT is used for POLYM in form of an aqueous solution or in form of an aqueous suspension. CAT can for example be used dissolved or suspended in the water that provides for WP1, CAT can be dissolved or suspended in the water that provides for WP2, or CAT can be used in form an aqueous solution or in form of an aqueous suspension that is added to OWE or to WOWE.
POLYM can be done in the presence of ADDIT, with ADDIT as defined herein, also with all its embodiments.
In WP1 or in WP2 further substances can be dissolved, such as ADDIT.
Also in the oil phase further substances can be contained, preferably in a dissolved state, such as ADDIT.
Preferably, when POLYM is done in the presence of ADDIT, then the total amount of ADDIT in POLYM is from 0.01 to 20 wt %, more preferably from 0.01 to 15 wt %, even more preferably from 0.01 to 10 wt %, especially from 0.01 to 7.5 wt %, the wt % being based on the weight of ISOCYAN.
The minimum amount of ADDIT in POLYM can also be 0.1 or 1 wt %, and this in combination with any embodiment of the upper ranges as defined herein;
so in another embodiment, the total amount of ADDIT in POLYM is from 0.1 to 20 wt %, more preferably from 0.1 to 15 wt %, even more preferably from 0.1 to 10 wt %, especially from 0.1 to 7.5 wt %, the wt % being based on the weight of ISOCYAN;
in another embodiment, the total amount of ADDIT in POLYM is from 1 to 20 wt %, more preferably from 1 to 15 wt %, even more preferably from 1 to 10 wt %, especially from 1 to 7.5 wt %, the wt % being based on the weight of ISOCYAN.
Preferably, when ADDIT is present in WP1, then the amount of ADDIT in WP1 is from 0.1 to 1.5 wt %, more preferably from 0.25 to 1.25 wt %, even more preferably from 0.4 to 1.0 wt %, the wt % being based on the weight of water in WP1.
Preferably, when ADDIT is present in WP2, then the amount of ADDIT in WP2 is from 0.1 to 1.5 wt %, more preferably from 0.25 to 1.25 wt %, even more preferably from 0.4 to 1.0 wt %, the wt % being based on the weight of water in WP1.
Preferably, when ADDIT is present in the oil phase, then the amount of ADDIT in the oil phase is from 0.01 to 0.5 wt %, more preferably from 0.01 to 0.3 wt %, the wt % being based on the weight of SOLVOIL in the oil phase;
in another embodiment, preferably, when ADDIT is present in the oil phase, then the amount of ADDIT in the oil phase is from 0.1 to 0.5 wt %, more preferably from 0.1 to 0.3 wt %, the wt % being based on the weight of SOLVOIL in the oil phase;
in another embodiment, preferably, when ADDIT is present in the oil phase, then the amount of ADDIT in the oil phase is from 1 to 0.5 wt %, more preferably from 1 to 0.3 wt %, the wt % being based on the weight of SOLVOIL in the oil phase.
When POLYM is done in an OWE, then preferably the amount of WP1 is from 1 to 5 times, more preferably from 2 to 4 times, of the weight of the oil phase.
When POLYM is done in a WOWE, then preferably the amount of WP1 is from 0.25 to 1.5 times, more preferably from 0.5 to 1 times, of the weight of the oil phase.
When POLYM is done in a WOWE, then preferably the amount of WP2 is from 1 to 5 times, more preferably from 2 to 4 times, of the weight of the oil phase.
Preferably, the reaction temperature TEMP3 of POLYM is from 20 to 150° C., more preferably from 20 to 150° C., even more preferably from 40 to 150° C., especially from 50 to 150° C., more especially from 60 to 150° C., even more especially from 65 to 150° C.
In case that POLYM is done at ambient pressure, than the reaction temperature TEMP3 of POLYM is from 30° C. to the boiling point of the reaction mixture at ambient pressure, more preferably from 40° C. to the boiling point of the reaction mixture at ambient pressure, even more preferably from 50° C. to the boiling point of the reaction mixture at ambient pressure, especially from 60° C. to the boiling point of the reaction mixture at ambient pressure, more especially from 65° C. to the boiling point of the reaction mixture at ambient pressure.
A particular preferred TEMP3 is from 65 to 80° C.
The pressure PRESS3 during POLYM is preferably ambient pressure. Of course it is possible to provide for elevated pressure, for example by simply closing the reaction apparatus or applying pressure by means of an inert gas, such as nitrogen or argon, in order to be able to carry out POLYM at a higher temperature than the boiling temperature of the reaction mixture at ambient pressure.
It is also possible that POLYM is done at a PRESS3 which is below ambient pressure.
Preferably, the reaction time TIME3 of POLYM is from 30 min 10 h, more preferably from 1 h to 5 h, even more preferably from 1.5 h to 4 h.
After POLYM any SOLVOIL is preferably removed from the reaction mixture or from MICROCAPS obtained from POLYM; the removal of SOLVOIL can be done by standard methods such as filtration, distillation, drying, or a combination thereof; distillation may for example be a distillation under elevated temperature, under reduced pressure or in form of an azeotropic distillation such as steam distillation.
After POLYM the MICROCAPS can be isolated with standard methods known to the skilled person, such as filtration, washing and drying. For washing also a redispersion of MICROCAPS in the washing medium is possible. Preferably, the isolation, especially a filtration is done while the reaction mixture is still hot. A removal of unwanted particles of large size can be done by a prefiltration with a respectively large mesh size before the isolation of the MICROCAPS by filtration with a respectively smaller mesh size is done.
Further subject of the invention is a microcapsules MICROCAPS;
with MICROCAPS as defined herein, also with all its embodiments.
Further subject of the invention is a microcapsule MICROCAPS obtainable or having been obtained by METHENCAPS;
with MICROCAPS and METHENCAPS as defined herein, also with all their embodiments.
Preferably, MICROCAPS are essentially free of any SOLVOIL;
more preferably, MICROCAPS are essentially of any solvent or plastiziser;
solvent or plastiziser may for example be SOLVOIL, oils, such as linseed oil, or phthalates, such as dioctylphthalate or diisodecylphthalate.
Preferably, MICROCAPS do not contain any SOLVOIL;
more preferably, MICROCAPS does not contain any solvent or plastiziser.
Further subject of the invention is a method METHPROTECT for protecting a coating composition COATCOMP against microorganisms;
the method comprising contacting the COATCOMP with microcapsules MICROCAPS,
COATCOMP is selected from the group consisting of architectural (interior and exterior) and marine paints and coatings, sealants (for example PU, Epoxy, Silicone), fishnet coatings, construction paints and coatings, oil and gas coatings, wood composite coatings and wood composites plastics, flooring paints and coatings, and combinations thereof;
wherein
wherein MICROCAPS are obtainable or have been prepared by METHENCAPS;
with MICROCAPS and METHENCAPS as defined herein, also with all their embodiments.
Microorganisms which can infest COATCOMP are for example algae, fungi or bacteria.
The protection of COATCOMP against microorganisms by METHPROTECT comprises for example controlling microorganisms in or on COATCOMP, and the protection of COATCOMP against harm by, or change by or infestation with microorganisms.
The contacting of COATCOMP with MICROCAPS can be done for example by incorporating MICROCAPS into COATCOMP. The preparation of a COATCOMP can comprise the mixing of the various components of the COATCOMP, the incorporation of MICROCAPS into the COATCOMP can for example be done at any step of the mixing of the components of the COATCOMP, for example by mixing the COATCOMP comprising all its components with MICROCAPS.
Paints can for example be water based paints or solvent based paints, the water based paints are usually more susceptible for microorganisms than the solvent based paints.
Further subject of the invention is COATCOMP comprising MICROCAPS,
with MICROCAPS obtainable or having been obtained by METHENCAPS;
and MICROCAPS, METHENCAPS and COATCOMP as defined herein, also with all their embodiments.

### EXAMPLES

Methods

Method for Determination of the Particle Size Distribution (PSD) Such as Volume Average Particle Size, D10, D50 and D90:
D10, D50 and D90: The particle diameter corresponding to 10%, 50% and 90% cumulative undersize particle size distribution based on volume. The D50 is also called the volume-median-diameter. Herein the unit of the values of D10, D50 and D90 is micrometer, if not otherwise stated.

1. PSD Equipment.

The particle size distributions of the samples were measured with Beckman Coulter LS 13 320, using a 5 mW laser diode with a wavelength of 750 nm. It also has a secondary tungsten-halogen light source for the Polarization Intensity Differential Scattering (PIDS) system. The light from the tungsten-halogen lamp is projected through a set of filters which transmit three wavelengths (450 nm, 600 nm and 900 nm) through two orthogonally oriented polarizers at each wavelength.

The machine uses both, Mie (light scattering, for small particles) and Fraunhofer (light diffraction, for big particles) theories for the interpretation of the signals.

Polarization Intensity Differential Scattering (PIDS) technology allows for detection of very small particles with very good resolution.

The PIDS measurements are added to the same deconvolution matrix that is used for diffraction sizing. The relative volume of particles in each size channel is determined by a solution for this matrix. The analysis is completely integrated, so although two methods are used, a single solution is obtained.

2. Sample Preparation

The samples are taken directly from the reaction slurry.

There is no specific concentration, at which the suspensions should be measured, since the optimum concentration depends on the particle size.

The machine determines the optimum for the measurement concentration of the particles based on the turbidity measurement.

So the sample slurry is just added (drop by drop) into the measuring cell containing water, until the right, that is the optimal turbidity is reached, this is signaled by the device.

Each sample is measured both as it is and after sonication for 2 min in USBath.

The results were very similar, which is an indication of good particle distribution and absence of agglomeration.

Method for Determination of the Content of Diuron in MICROCAPS

Reagents:
Water, HPLC grade, Fisher Scientific
Acetonitrile, HPLC grade, Fisher Scientific
Methanol, HPLC grade, Fisher Scientific
Trifluoroacetic acid (TFA), HPLC grade, Fisher Scientific
Diuron reference standard, 99%

Preparation of Diuron Standard for Calibration:

Weigh 25 mg of diuron into 25 mL volumetric flask and dilute to volume with methanol. Use this standard stock solution to prepare the calibration solutions as shown in table 1. The calibration standards are prepared in 10 mL volumetric flasks and diluted with methanol.

TABLE 1

| Calibration Standard | microliter of | Concentration |
|---|---|---|
| ID | stock standard | microgram/mL |
| STD 1 | 100 | 10 |
| STD 2 | 200 | 20 |
| STD 3 | 500 | 50 |
| STD 4 | 750 | 75 |
| STD 5 | 1000 | 100 |

Sample Dilution Solvent:

In a 1 L bottle mix 5 mL of trifluoroactic acid and 1000 mL of methanol

Sample Preparation:

Weigh 100 mg of MICROCAPS comprising diuron as BIOC (encapsulated diuron) into 100 mL volumetric flask in triplicate. Dilute to 100 ml with Sample Dilution Solvent. Sonicate the samples with USBath for 30 minutes. Filter an aliquot through 0.45 micrometer PVFD syringe filter and further dilute sample with Sample Dilution Solvent to within the calibration curve.

HPLC Conditions:
Column: YMC-Pack ODS-AQ (YMC Europe GmbH) 2.0×250 mm, S-5 μm, 12 nm, p/n AQ12S05-2502WT
Column temperature: 35° C.
Injection Volume: 5 microliter
Detection: UV at 240 nm
Run time: 40 min
Mobile phase A: water
Mobile phase B: acetonitrile

Gradient:

| Time | Flow | A | B |
|---|---|---|---|
| (min) | mL/min | vol % | vol % |
| 0 | 0.2 | 95 | 5 |
| 25 | 0.2 | 50 | 50 |
| 27 | 0.2 | 15 | 85 |
| 27.1 | 0.2 | 95 | 5 |
| 37 | 0.2 | 95 | 5 |

Method for determination of the Leaching Rate with leach water:

Aliquots of leach water from any leaching test is analyzed by this HPLC method without any additional sample preparation.

Materials and Devices
DABCO purchased from Sigma Aldrich
Diuron CAS 330-54-1, 3-(3,4-Dichlorophenyl)-1,1-dimethylurea

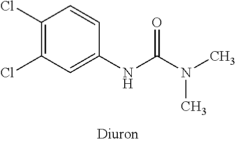

Gum Arabic CAS 9000-01-5, purchased from Sigma Aldrich (“Gum arabic from acacia tree, spray dried, product 51198)
P123 Pluronic® P-123, CAS Number 9003-11-6, Poly (ethylene glycol)-block-poly (propylene glycol)-block-poly (ethylene glycol), PEG-PPG-PEG, average molecular weight ca. 5′800, purchased from Sigma-Aldrich
PVA CAS 9002-89-5, Mowiol® 4-88, polyvinyl alcohol, MW 31′000, 86.7-88.7 mol-% hydrolysis, purchased from Sigma-Aldrich
Toluene CAS 108-88-3, ACS reagent, purity 99.5% or more
USBath ultrasonic bath Sonorex super from BANDELIN electronic GmbH & Co. KG, Germany, 100% intensity, if not otherwise stated
U-Turrax T 25 digital ULTRA-TURRAX from IKA®-Werke GmbH & CO. KG, Germany
VKS20 Desmodur® VKS 20, a mixture of diphenylmethane-4,4′-diisocyanate (MDI) with isomers and higher functional homologues (PMDI), purchased from Covestro AG, Leverkusen, Germany

### Example 1

First Water Phase WP1:

20 g Diuron

40 g of a 0.5 wt % PVA solution in water

Mix the two components, apply USBath for 30 s to achieve a good dispersion.

Oil Phase:

40 g VKS20

40 g ethyl acetate

0.2 g of a 5 wt % P123 solution in ethyl acetate

Mix the three components to obtain a homogeneous solution.

Second Water Phase WP2:

280 g of a 0.5 wt % PVA solution in water

Catalyst Solution:

40 ml of a 5 wt % DABCO solution in water

Synthesis Procedure:
Add freshly prepared WP1 slowly to the oil phase while applying U-Turrax at 7′000 rpm for 30 to 60 s for providing a homogenous O/W emulsion.
Add this freshly prepared homogenous O/W emulsion to WP2 and apply U-Turrax 5′000 rpm for 30 to 60 s to obtain a W/O/W emulsion
Add the catalyst solution to the W/O/W emulsion and stir the W/O/W emulsion on a magnetic stirrer at 75° C. for 2 h, a suspension forms.

The resulting suspension was filtered while still hot through a 100 micrometer paper filter.

The filtrate was filtered while still hot through a 10 micrometer paper filter and the resulting cake was washed with water of ambient temperature

The washed wet cake was dried overnight under air atmosphere at ambient temperature.

The content of BIOC in MICROCAPS was 14.8 wt %.

### Example 3

Oil Phase:

100 g of a 0.02 wt % P123 solution in ethyl acetate

30 g Diuron

70 g VKS20

Mix the two components and disperse Diuron effectively by using U-Turrax 3′000 rpm for 1 min

Water Phase WP:

600 g of a 0.5 wt % PVA solution in water

1.2 g Gum Arabic

Mix the two components to obtain a homogeneous solution

Catalyst Solution:

100 g of a 5 wt % DABCO solution in water

Synthesis Procedure:

Add freshly prepared oil phase to WP and apply U-Turrax at 4′000 rpm for 40 s. An O/W emulsion is formed. Add the catalyst solution to the O/W emulsion and place the O/W emulsion onto a magnetic stirrer and stir with ca. 300 rpm at 70° C. for 2 h. A suspension forms.

The resulting suspension was filtered while still hot through a 100 micrometer paper filter. The filtrate was filtered while still hot through a 10 micrometer paper filter and the resulting cake was washed with water of ambient temperature

The washed wet cake was dried overnight under air atmosphere at ambient temperature.

The content of BIOC in MICROCAPS was 21 wt %.

### Example 4

Water Phase WP:

600 g of a 0.5 wt % PVA solution in distilled water.

100 g of a 5 wt % DABCO aqueous solution

Mix the two components to obtain a homogeneous solution

Oil Phase:

Prepare 100 g of a 0.2 wt % P123 solution in toluene. Dissolve 70 g of VKS20 in this solution. Add 30 g of Diuron and homogenize by application for ca. 1 min of USBath to obtain a homogeneous suspension.

Synthesis Procedure:

Add the freshly prepared oil phase to WP. Homogenize by applying U-Turrax at 5′000 rpm for 30 to 60 s. Put the resulting O/W emulsion on a magnetic stirrer running at 200 rpm right after the homogenization and stir the mixture for 3 h at 75° C., a suspension forms.

The resulting suspension was filtered while still hot through a 100 micrometer paper filter. The filtrate was filtered while still hot through a 10 micrometer paper filter and the resulting cake was washed two times by re-dispersing the press cake in 600 ml of water at room temperature and filtering. Dry over night at 70° C. under slight vacuum.

The content of BIOC in MICROCAPS was 18.6 wt %.

### Example 5

Example 3 was repeated with the sole difference that in the Synthesis procedure the U-Turrax was not applied with 4′000 rpm but with 2′000 rpm.

The content of BIOC in MICROCAPS was 15.1 wt %.

### Example 6

First Water Phase WP1:

100 g Diuron

150 g of a 0.5 wt % PVA solution in water

Use the U-Turrax at 15′000 to 20′000 rpm for ca. 30 s to achieve good dispersion.

Oil Phase:

200 g VKS20

150 g of a 0.1 wt % P123 solution in ethyl acetate

Mix the two components to obtain a homogeneous solution.

Second Water Phase WP2 with catalyst:

1000 g of a 0.5 wt % PVA solution in water

200 ml of a 5 wt % DABCO solution in water

4 g Gum Arabic

Mix the three components at 40° C. to obtain a homogeneous solution.

Synthesis Procedure:

Add WP1 to Oil phase and use U-Turrax at 15′000 to 20′000 rpm for 2 to 3 min to achieve homogenous O/W emulsion. Add the freshly prepared O/W emulsion to the WP2 phase while heating the WP2 to 75° C. and while stirring with U-Turrax at 7000 rpm and with a mechanical stirrer at 300 rpm. When the temperature reaches 55 to 60° C., the U-Turrax was switched off, but the stirring with the mechanical stirrer continued. After switching off of the U-Turrax the targeted 75° C. were reached in ca. 20 min and then the mixture was stirred for 2 h at 75° C. with the mechanical stirrer. A suspension formed.

The resulting suspension was filtered while still hot through a 100 micrometer paper filter. The filtrate was filtered while still hot through a 10 micrometer paper filter and the resulting cake was washed with water of ambient temperature

The washed wet cake was dried overnight under air atmosphere at ambient temperature.

### Example 1 to 6: Results of Particle Size Distribution

| Example | D10 | D50 | D90 |
|---|---|---|---|
| 4 | 3.0 | 14.0 | 25.1 |
| 5 | 0.5 | 3.4 | 8.9 |
| 1 | 0.3 | 7.9 | 18.5 |
| 3 | 0.6 | 10.5 | 25.3 |
| 6 | 0.4 | 8.8 | 25.3 |

Sample Paint Preparation

MICROCAPS is incorporated into a base paint formulation by mixing the base paint formulation with MICROCAPS in an amount representing approximately 4000 ppm of the BIOC to become the sample paints. An analytical assay by HPLC is done of these sample paints to determine the concentration of BIOC in the paint formulation. The sample paint is then kept and aged at 50° C. aged in an oven for 2 weeks. After aging, the sample paint is again analyzed by HPLC to determine the content of BIOC in the paint formulation.

The paint is made using the formulation below in the following manner. All materials are weighed out using a Mettler Toledo Precision Balance. Deionized water (10.57 wt %) is added to a 1-pint paint can. A VMA Getzmnann model CV3 dispermat is used to mix the paint.

Propylene glycol (2.99 wt %), ethylene glycol (2.20 wt %) and Natrosol (0.31 wt %) are added and the content of the paint can is mixed with the dispermat at 1500 rpm. Next, Triton CF-10 (0.22 wt %), Tamol 731A (0.26 wt %) and Colloids 643 (0.09 wt %) are added to the paint can, the content is mixed for 5 minutes, then the following materials are added to the paint can: KTPP (0.13 wt %), Duramite (15.34 wt %), Icekap K (2.07 wt %), Ti-Pure R902 (21.98 wt %), and Attagel 50 (0.26 wt %). Then the samples of MICROCAPS are added to the paint (in an appropriate amount to equal around 4000 ppm BIOC according the concentration of the sample).

The content of the paint can is mixed in the dispermat at 3000 rpm for 10 minutes, then the dispermat is turned down to 1000 rpm and the following materials are added: Rhoplex AC-264 (32.33 wt %), deionized water (10.02 wt %), texanol (0.97 wt %) and Colloids 643 (0.26 wt %), then the paint is allowed to mix at 1000 rpm for further 2 to 3 minutes and then the paint can is taken off the dispermat to be used for the experiments.

The amounts of the components in the base paint formulation are given in table 3 in wt % based on the weight of the base paint formulation without MICROCAPS.

TABLE 3

| Chemical | Amount [w %] | Supplier |
|---|---|---|
| Water | 10.57% | Deionized |
| propylene glycol | 2.99% | Fisher |
| ethylene glycol | 2.20% | Fisher |
| Natrosol 250 MHR | 0.31% | Ashland |
| Triton CF-10 | 0.22% | Dow |
| Tamol 731A | 0.26% | Dow |
| Colloids 643 | 0.09% | Solvay |
| KTPP | 0.13% | American Elements |
| Duramite | 15.34% | Imerys |
| Icekap K | 2.07% | Burgess |
| Ti-Pure R902 | 21.98% | The Chemours Company |
| Attagel 50 | 0.26% | BASF |
| Rhoplex AC-264 | 32.33% | DOW |
| Water | 10.02% | Deionized |
| Texanol | 0.97% | Eastman |
| Colloids 643 | 0.26% | Solvay |

Panel Preparation:

Calcium silicate panels from McMaster-Carr 9353K31 and 9353K41 are used as the test substrate.

The calcium silicate panels are cut into 10 cm by 10 cm squares and then painted on one side with a standard primer (Kilz® Primers, Kilz 2® Latex, from Home Depot) purchased commercially.

After the primer has air dried for 24 h, the test panel is weighed to determine the initial weight. A first coat of the sample paint is applied to onto the primer on the test panel and the test panel is weighed before drying. After air drying for 12 h, the test panel is weighed again to determine the percent solids in this first coat. A second coat of the sample paint is then applied onto the dried first coat, and the test panel is weighed before and after drying for 72 h.

In this way, a total of two panels are prepared from each sample paint to provide duplicate measurements. All samples panels are prepared in parallel to achieve uniformity.

Leaching Test:

Each sample panel is placed individually into a crystalizing dish with a volume of ca 500 ml. The panels are covered with 250 mL of deionized water and then the dishes are covered, with parafilm. Each crystalizing dish is placed in a dark cabinet for the designated time for each leaching cycle. The times, also called leach time, for the leaching cycles are 24 hours, 72 hours, 144 hours, 216 hours, and 288 hours. at the end of each leaching cycle, all of the water from each crystalizing dish is collected, called leach water. For the next leaching cycle the panel is again covered with 250 ml of deionized water. The dish is covered again with parafilm and placed again in the cabinet for the respective time of the leaching cycle. The leach water of each leaching cycle is analyzed by HPLC as described under Methods for its content of diuron, which leached from the coating of the panel into the water. Results are shown in table 2, the leaching is given in % by weight at the respective leach time. The total amount of leaching can be calculated be summing up the individual amounts of leaching at the respective leach time.

### Comparative Example 1

A paint was prepared according to the description Sample Paint Preparation, except for the difference that not MICROCAPS was incorporated into the base paint formulation, but diuron as such was used instead. The amount of diuron in the resulting panel is given in Table 2.

### Comparative Example 2

Diuron-containing microcapsules were prepared according to Example 4 of US 2016/0088837 A1 and were used to prepare a paint according to Sample Paint Preparation.

TABLE 2

| | Initial | | | | |
|---|---|---|---|---|---|
| | amount | Leaching of Diuron | | | |
| | of diuron | at leach time | | | |
| Sample panel | on panel | 24 h | 144 h | 216 h | 288 h |
| containing | [microgram] | [%] | [%] | [%] | [%] |
| Comparative | 6324 | 27.2 | 12.9 | 11.6 | 9.0 |
| Example 2 | | | | | |
| Comparative | 3760 | 36.1 | 16.0 | 11.3 | 8.3 |
| Example 1 | | | | | |
| Example 4 | 4700 | 18.0 | 6.4 | 5.0 | 3.6 |
| Example 5 | 4968 | 24.4 | 10.2 | 8.5 | 6.3 |
| Example 1 | 7600 | 5.9 | 1.7 | 1.3 | 0.8 |
| Example 3 | 6138 | 14.0 | 4.9 | 4.0 | 2.9 |

1. A method METHENCAPS for preparation of microcapsules MICROCAPS;
with MICROCAPS comprising a biocide BIOC and a microencapsulation material MICROENCAPSMAT;
BIOC is a biocide that is active against microorganisms;
MICROENCAPSMAT comprises a polyurea polymer POLYUREAPOLYM;
METHENCAPS comprises a polymerization POLYM of a polyisocyanate ISOCYAN in the presence of water, or of ISOCYAN with a polyamine, or by a combination of both;
POLYM provides POLYUREAPOLYM;
BIOC is present during POLYM and is microencapsulated by MICROENCAPSMAT during POLYM;
wherein
BIOC is present in POLYM in solid form;
POLYM is done in the presence of a solvent SOLVOIL, SOLVOIL is selected from the group consisting of ethyl acetate, xylene, MTBE, and toluene.

2. The method according to claim 1, wherein
BIOC is diuron.

3. The method according to claim 1, wherein
MICROCAPS have a volume averaged particle size of 0.3 to 100 micrometer.

4. The method according to claim 1, wherein
ISOCYAN is a compound of formula (XX) or a prepolymer PREPOLYM;
R30 [symbol] N═C═O]ₙ₄ (XX)
wherein
n4 is an integer that is equal or greater than 2;
R30 is a group linking the 2 or more isocyanate residues together, including any aromatic, aliphatic, or cycloaliphatic groups, or combinations of any of aromatic, aliphatic, or cycloaliphatic groups, which are capable of linking the isocyanate groups together;
PREPOLYM is an isocyanate which is prepared by a reaction between compound of formula (XX) with a compound COMPOHNH, COMPOHNH is selected from the group consisting of polyalcohol, water, polyamine, and mixtures thereof;
wherein in said reaction COMPOHNH is present in substoichiometric amounts with regard to ISOCYAN.

5. The method according to claim 1, wherein
ISOCYAN is selected from the group consisting of compound of formula (XXI), compound of formula (XXII), methylendi(phenylisocyanate), compound of formula (BIPHEN), compound of formula (PHEN), 1,5-naphthylene diisocyanate, hydrogenated methylendi(phenylisocyanate), compound of formula (HPHEN), compound of formula (XXIII), compound of formula (XXIV), compound of formula (XXV), and polymeric polyisocyanate, and mixtures thereof; 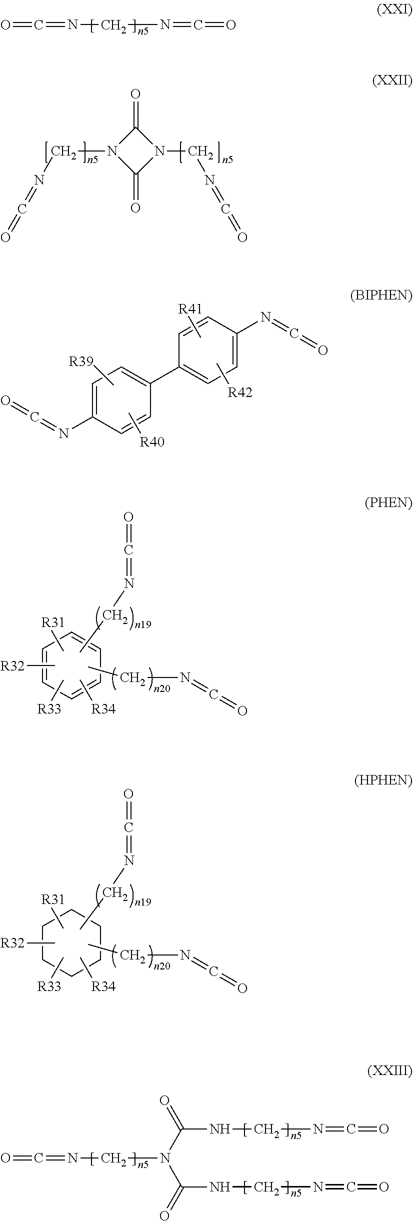 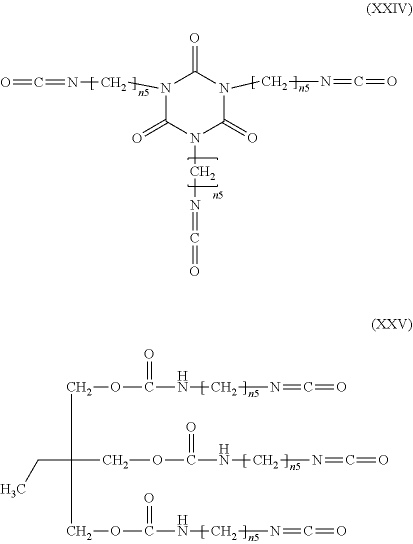
wherein
n5 is an integer from 2 to 18;
R39, R40, R41 and R42 are identical or different and independently from each other selected from the group consisting of H, F, Cl, Br, C₁₋₄ alkyl and C₁₋₄ alkoxy;
n19 and n20 are identical or different and independently from each 0, 1, 2, 3 or 4;
R31, R32, R33 and R34 are identical or different and independently from each selected from the group consisting of H, F, Cl, Br, C₁₋₄ alkyl and C₁₋₄ alkoxy.

6. The method according to claim 1, wherein
ISOCYAN is selected from the group consisting of methylendi(phenylisocyanate), polymeric methylendi(phenylisocyanate), hydrogenated methylendi(phenylisocyanate), isophoron diisocyanate, hexamethylene diisocyanate, toluene diisocyanate, and mixtures thereof.

7. The method according to claim 4, wherein
the polyalcohol is a polyalcohol ALC;
ALC is selected from the group consisting of polyvinylalcohol, poly (ethylene glycol), poly (propylene glycol), poly (ethylene glycol)-block-poly (propylene glycol), poly (ethylene glycol)-block-poly (propylene glycol)-block-poly (ethylene glycol), ethylene glycol, propylene glycol, compound of formula (X), and mixtures thereof; 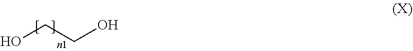
wherein
n1 is in integer from 1 to 9.

8. The method according to claim 1, wherein
the polyamine is a polyamine AMI;
AMI is selected from the group consisting of compound of formula (XI), compound of formula (XIV), compound of formula (XII), compound of formula (XXVII), polymeric methylendi(aniline), hydrogenated methylendi(aniline), cystamine, triethylene glycol diamine, compound of formula (XVII), compound of formula (XXVI), and mixtures thereof; 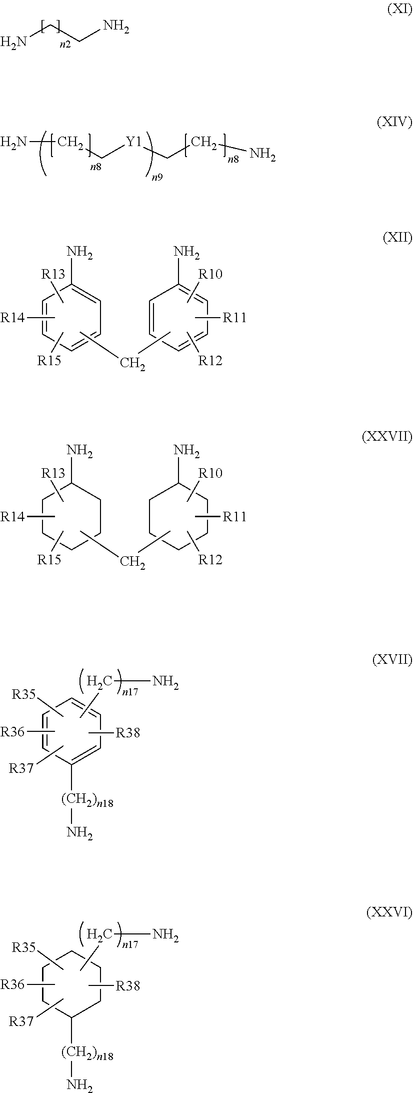
wherein
n2 is in integer from 1 to 9;
R10, R11, R12, R13, R14, R15, R35, R36, R37 and R38 are identical or different and are independently from each other selected from the group consisting of H, halogen, and C₁₋₄ alkyl;
n8 is an integer from 1 to 5;
n9 is 1, 2, 3, 4, 5, 6 or 7;
Y1 is selected from the group consisting of S—S, (CH₂)ₙ₆—Z1-(CH₂)ₙ₆, and Z1-(CH₂)ₙ₂—Z1;
n6 is 0, 1, 2, 3 or 4;
Z1 is selected from the group consisting of NH, O, and S;
n17 and n18 are identical or different and are independently from each other an integer number selected from the group consisting of 0, 1, 2, 3 and 4.

9. The method according to claim 1, wherein
MICROENCAPSMAT comprises a polyurethane polymer POLYURETHPOLYM.

10. The method according to claim 9, wherein
POLYURETHPOLYM is made by polymerization of ISOCYAN with a polyalcohol.

11. The method according to claim 1, wherein
POLYM is done in the presence of a polyalcohol.

12. The method according to claim 1, wherein
the polyalcohol is ALC, wherein ALC
is selected from the group consisting of polyvinylalcohol, poly (ethylene glycol), poly (propylene glycol), poly (ethylene glycol)-block-poly (propylene glycol), poly (ethylene glycol)-block-poly (propylene glycol)-block-poly (ethylene glycol), ethylene glycol, propylene glycol, compound of formula (X), and mixtures thereof; 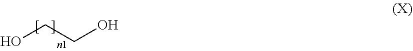
wherein
n1 is in integer from 1 to 9.

13. The method according to claim 1, wherein
POLYM is done in the presence of a catalyst CAT;
CAT is selected from the group consisting of DABCO, dimethylcyclohexylamine, dimethylethanolamine, triethylenediamine, N,N,N′,N″,N″-pentamethyldiethylenetriamine, 1,2-dimethylimidazol, N,N,N′,N′-tetramethyl-1,6-hexanediamine, N,N′,N′-trimethylaminoethylpiperazine, 1,1′-[[3-(dimethyl amino)propyl]imino]bispropane-2-ol, N,N,N′-trimethylaminoethylethanolamine, and N,N′,N″-tris(3-dimethylaminopropyl)-hexahydro-s-triazine.

14. The method according to claim 1, wherein
POLYM is done in the presence of water.

15. The method according to claim 1, wherein
BIOC in present in POLYM in form of a suspension.

16. The method according to claim 1, wherein
POLYM is done in an emulsion.

17. The method according to claim 1, wherein
after POLYM any SOLVOIL is removed from the reaction mixture or from MICROCAPS obtained from POLYM.

18. A method of producing MICROCAPS from METHENCAPS;
with MICROCAPS and METHENCAPS as defined in claim 1.

19. The method of producing MICROCAPS according to claim 18; wherein
MICROCAPS are essentially free of any SOLVOIL.

20. A method METHPROTECT for protecting a coating composition COATCOMP against microorganisms;
the method comprising contacting the COATCOMP with microcapsules MICROCAPS,
COATCOMP is selected from the group consisting of architectural (interior and exterior) and marine paints and coatings, sealants, fishnet coatings, construction paints and coatings, oil and gas coatings, wood composite coatings and wood composites plastics, flooring paints and coatings, and combinations thereof;
wherein MICROCAPS are obtainable by METHENCAPS;
with MICROCAPS and METHENCAPS as defined in claim 1.

21. The method METHPROTECT according to claim 20; wherein
the contacting of COATCOMP with MICROCAPS is done by incorporating MICROCAPS into COATCOMP.

22. A COATCOMP comprising MICROCAPS;
with MICROCAPS obtainable by METHENCAPS;
with MICROCAPS and METHENCAPS as defined in claim 1 and COATCOMP is selected from the group consisting of architectural (interior and exterior) and marine paints and coatings, sealants, fishnet coatings, construction paints and coatings, oil and gas coatings, wood composite coatings and wood composites plastics, flooring paints and coatings, and combinations thereof.
